(19) United States
(12) Patent Application Publication
(10) Pub. No.: US 2016/0215181 A1
(43) Pub. Date: Jul. 28, 2016

(54) OPTICAL PRESSURE-SENSITIVE ADHESIVE SHEET

(71) Applicant: NITTO DENKO CORPORATION, Osaka (JP)

(72) Inventors: Masato FUJITA, Osaka (JP); Takahiro NONAKA, Osaka (JP); Shoichi MATSUDA, Osaka (JP); Hiroshi TOMOHISA, Osaka (JP)

(73) Assignee: NITTO DENKO CORPORATION, Osaka (JP)

(21) Appl. No.: 15/002,472

(22) Filed: Jan. 21, 2016

(30) Foreign Application Priority Data
Jan. 22, 2015 (JP) 2015-010202
Sep. 8, 2015 (JP) 2015-177026

(51) Int. Cl. C09J 139/06; C09J 133/08; C09J 11/06; C09J 151/00; C09J 9/00

(52) U.S. Cl. CPC C09J 139/06; C09J 151/003; C09J 9/00; C09J 11/06; C09J 133/08; C08K 5/132

(57) ABSTRACT

An optical pressure-sensitive adhesive sheet for silver nanowire layer use includes a pressure-sensitive adhesive layer. The amount of acrylic acid ions extracted from the pressure-sensitive adhesive layer with pure water at 100° C. for 45 minutes is equal to or less than 5 μg per gram of the pressure-sensitive adhesive layer, where the amount is measured by ion chromatography. The pressure-sensitive adhesive layer is preferably an acrylic pressure-sensitive adhesive layer.

### TECHNICAL FIELD

The present invention generally relates to optical pressure-sensitive adhesive sheets. More specifically, the present invention relates to an optical pressure-sensitive adhesive sheet for silver nanowire layer use.

### BACKGROUND ART

A variety of fields has adopted liquid crystal displays (LCDs) and other display devices, and touch screens (touch-screen panels) and other input devices which are used in combination with such display devices. Devices such as the display devices and input devices adopt pressure-sensitive adhesive sheets each including a pressure-sensitive adhesive layer so as to bond or affix optical elements (optical members). For example, Unexamined Patent Application Publication (JP-A) No. 2003-238915 (PTL 1), JP-A No. 2003-342542 (PTL 2), and JP-A No. 2004-231723 (PTL 3) disclose the use of transparent pressure-sensitive adhesive sheets to bond touch screens with display members and/or optical elements.

Some of optical elements for use in the devices such as the display devices and input devices might be degraded by ultraviolet rays. Thus, the pressure-sensitive adhesive sheets may require ultraviolet absorptivity (ultraviolet shielding property, UV cutting property). For example, JP-A No. 2013-75978 (PTL 4) proposes, as a pressure-sensitive adhesive sheet having the property, a transparent pressure-sensitive adhesive sheet including a pressure-sensitive adhesive layer that includes an ultraviolet absorber.

In particular, a pressure-sensitive adhesive sheets may be directly applied to a thin metal film in uses such as production of capacitive touch screens. The term “thin metal film(s)” as used herein generically refers to thin metal films and thin metal oxide films, such as ITO (indium tin oxide) films. The pressure-sensitive adhesive sheet for use in these uses requires so-called “non-corrosivity” by which the pressure-sensitive adhesive sheet does not approximately corrode the thin metal film.

Assume that a pressure-sensitive adhesive sheet including an acrylic polymer or any other polymer derived from constitutive monomer components including a carboxy-containing monomer is used as the pressure-sensitive adhesive sheet to be directly applied to a thin metal film. Disadvantageously, however, the resulting article including the thin metal film and the pressure-sensitive adhesive sheet, when stored under high-humidity conditions, suffers from change in resistance of the thin metal film, namely, suffers from corrosion of the thin metal film.

In contrast, JP-A No. 2010-195942 (PTL 5) discloses a pressure-sensitive adhesive sheet that includes at least one pressure-sensitive adhesive layer formed from (derived from) a pressure-sensitive adhesive composition, where the pressure-sensitive adhesive composition comprises an acrylic polymer having a total content of acrylic acid and methacrylic acid of equal to or less than 10 percent by weight of all monomer components to constitute the acrylic polymer. When an extract is extracted from the pressure-sensitive adhesive sheet, the total amount of acrylic acid ions and methacrylic acid ions in the extract is equal to or less than 20 ng per unit area, square centimeter, of the pressure-sensitive adhesive layer. This pressure-sensitive adhesive sheet is a pressure-sensitive adhesive sheet including an acrylic polymer derived from constitutive monomer components including acrylic acid and/or methacrylic acid, but still has excellent non-corrosivity with respect to ITO films and other thin metal films.

### CITATION LIST

### Patent Literature

PTL 1: JP-A No. 2003-238915

PTL 2: JP-A No. 2003-342542

PTL 3: JP-A No. 2004-231723

PTL 4: JP-A No. 2013-75978

PTL 5: JP-A No. 2010-195942

### SUMMARY OF INVENTION

### Technical Problem

Instead of ITO films, films including a silver nanowire layer (Ag NW layer) have been increasingly used as thin metal films in uses such as capacitive touch screen production. The pressure-sensitive adhesive sheet, in which the total amount of acrylic acid ions and methacrylic acid ions extracted from the pressure-sensitive adhesive sheet is equal to or less than 20 ng per unit area (square centimeter) of the pressure-sensitive adhesive layer, has excellent non-corrosivity with respect to the ITO films, but fails to have sufficient non-corrosivity with respect to the silver nanowire layer. Specifically, a pressure-sensitive adhesive sheet to be applied to an optical element including a silver nanowire layer requires higher non-corrosivity as compared with the non-corrosivity with respect to the ITO film. This is probably because silver in the silver nanowire layer is susceptible to ionization by the action of acrylic acid ions from the pressure-sensitive adhesive layer. In particular, ultraviolet irradiation may often promote the corrosion of the silver nanowire layer. Under such present circumstances, there is a need for providing a pressure-sensitive adhesive sheet that has excellent non-corrosivity (in particular, UV-resistant non-corrosivity) with respect to the silver nanowire layer. As used herein the term “UV-resistant non-corrosivity” refers to non-corrosivity in an environment with the application of an ultraviolet ray.

Accordingly, the present invention has an object to provide an optical pressure-sensitive adhesive sheet that has excellent non-corrosivity (in particular, UV-resistant non-corrosivity) with respect to silver nanowire layers.

### Solution to Problem

After intensive investigations to achieve the object, the inventors of the present invention found that an optical pressure-sensitive adhesive sheet that includes a pressure-sensitive adhesive layer and is for silver nanowire layer use (to be applied to the silver nanowire layer) can have excellent non-corrosivity with respect to silver nanowire layers by minimizing the amount of acrylic acid ions extracted from the pressure-sensitive adhesive layer. The present invention has been made based on these findings.

Specifically, the present invention provides, in an embodiment, an optical pressure-sensitive adhesive sheet for silver nanowire layer use, where the optical pressure-sensitive adhesive sheet includes a pressure-sensitive adhesive layer. The amount of acrylic acid ions extracted from the pressure-sensitive adhesive layer with pure water at 100° C. for 45 minutes is equal to or less than 5 μg per gram of the pressure-sensitive adhesive layer, where the amount is measured by ion chromatography.

The pressure-sensitive adhesive layer is preferably an acrylic pressure-sensitive adhesive layer including an acrylic polymer.

The pressure-sensitive adhesive layer preferably includes an ultraviolet absorber.

The ultraviolet absorber preferably has an absorbance A of equal to or less than 0.5, where the absorbance A is specified as an absorbance of a 0.08% solution of the ultraviolet absorber in toluene and is determined upon irradiation of the solution with light at a wavelength of 400 nm.

The ultraviolet absorber is preferably at least one ultraviolet absorber selected from the group consisting of benzotriazole ultraviolet absorbers, benzophenone ultraviolet absorbers, and hydroxyphenyltriazine ultraviolet absorbers.

The pressure-sensitive adhesive layer preferably contains the ultraviolet absorber in a proportion of 0.01 to 10 parts by weight per 100 parts by weight of a base polymer in the pressure-sensitive adhesive layer.

The optical pressure-sensitive adhesive sheet is preferably an optical pressure-sensitive adhesive sheet for use in a film sensor.

### Advantageous Effects of Invention

The optical pressure-sensitive adhesive sheet according to the embodiment of the present invention has excellent non-corrosivity with respect to silver nanowire layers. In particular, the optical pressure-sensitive adhesive sheet has excellent non-corrosivity in an environment with the application of an ultraviolet ray. The optical pressure-sensitive adhesive sheet is therefore preferably used typically in applications in which the optical pressure-sensitive adhesive sheet is applied to (affixed to) optical elements each including a silver nanowire layer, and, in particular, to silver nanowire films and any other transparent conductive films each including a silver nanowire layer.

### BRIEF DESCRIPTION OF DRAWINGS

FIG. 1 is a schematic cross-sectional view of an exemplary optical product including an optical pressure-sensitive adhesive sheet according to an embodiment of the present invention;

FIG. 2 is a schematic cross-sectional view of another exemplary optical product including the optical pressure-sensitive adhesive sheet according to the embodiment of the present invention;

FIG. 3 is a schematic view (top plan view) of a test specimen used in UV-resistant non-corrosivity evaluation on double-sided pressure-sensitive adhesive sheets prepared in examples and comparative examples; and

FIG. 4 is a schematic view (cross-sectional view taken along the line A-A′ of FIG. 3) of the test specimen used in UV-resistant non-corrosivity evaluation on the double-sided pressure-sensitive adhesive sheets prepared in the examples and comparative examples.

### DESCRIPTION OF EMBODIMENTS

The optical pressure-sensitive adhesive sheet according to the embodiment of the present invention for silver nanowire layer use includes a pressure-sensitive adhesive layer as follows. When the pressure-sensitive adhesive layer is subjected to extraction with pure water at 100° C. for 45 minutes, the amount of acrylic acid ions extracted from the pressure-sensitive adhesive layer is equal to or less than 5 μg per gram of the pressure-sensitive adhesive layer. This pressure-sensitive adhesive layer is herein also referred to as a “pressure-sensitive adhesive layer for use in the present invention”. The “optical pressure-sensitive adhesive sheet according to the embodiment of the present invention for silver nanowire layer use” is herein also simply referred to as an “optical pressure-sensitive adhesive sheet according to the embodiment of the present invention”. As used herein the term “pressure-sensitive adhesive sheet” also refers to and includes a “pressure-sensitive adhesive tape”. Specifically, the optical pressure-sensitive adhesive sheet according to the embodiment of the present invention may also be a pressure-sensitive adhesive tape having a tape-like shape.

The optical pressure-sensitive adhesive sheet according to the embodiment of the present invention is not limited in shape or form, as long as the pressure-sensitive adhesive layer for use in the present invention defines or provides an adhesive face (pressure-sensitive adhesive layer surface) to be applied to a silver nanowire layer side. The silver nanowire layer side is exemplified by, but is not limited to, an optical element at which the silver nanowire layer is present, in an optical product. For example, the optical pressure-sensitive adhesive sheet may be a single-sided pressure-sensitive adhesive sheet having an adhesive face as only one side thereof, or a double-sided (double-coated) pressure-sensitive adhesive sheet having adhesive faces as both sides thereof. Assume that the optical pressure-sensitive adhesive sheet according to the embodiment of the present invention is a double-sided pressure-sensitive adhesive sheet. In this case, the optical pressure-sensitive adhesive sheet may have two adhesive faces provided by the pressure-sensitive adhesive layer(s) for use in the present invention. Alternatively, the optical pressure-sensitive adhesive sheet may have one adhesive face provided by the pressure-sensitive adhesive layer for use in the present invention, and the other adhesive face provided by another pressure-sensitive adhesive layer (other pressure-sensitive adhesive layer) than the pressure-sensitive adhesive layer for use in the present invention. The optical pressure-sensitive adhesive sheet is preferably a double-sided pressure-sensitive adhesive sheet from the viewpoint of bonding between two adherends.

The optical pressure-sensitive adhesive sheet according to the embodiment of the present invention may be a so-called a pressure-sensitive adhesive sheet “with no carrier”, where the pressure-sensitive adhesive sheet include no carrier (carrier layer), or a pressure-sensitive adhesive sheet including a carrier (substrate). As used herein a pressure-sensitive adhesive sheet “with no carrier” is also referred to as a “pressure-sensitive adhesive transfer sheet”; and a pressure-sensitive adhesive sheet including a carrier is also referred to as a “carrier-supported pressure-sensitive adhesive sheet”. Examples of the pressure-sensitive adhesive transfer sheet include, but are not limited to, a double-sided pressure-sensitive adhesive sheet including the pressure-sensitive adhesive layer for use in the present invention alone; and a double-sided pressure-sensitive adhesive sheet including the pressure-sensitive adhesive layer for use in the present invention and another pressure-sensitive adhesive layer (pressure-sensitive adhesive layer other than the pressure-sensitive adhesive layer for use in the present invention). Examples of the carrier-supported pressure-sensitive adhesive sheet include, but are not limited to, a single-sided pressure-sensitive adhesive sheet including a carrier and the pressure-sensitive adhesive layer for use in the present invention at one side of the carrier; a double-sided pressure-sensitive adhesive sheet including a carrier, and the pressure-sensitive adhesive layer for use in the present invention at both sides of the carrier; and a double-sided pressure-sensitive adhesive sheet including a carrier, the pressure-sensitive adhesive layer for use in the present invention at one side of the carrier, and another pressure-sensitive adhesive layer at the other side of the carrier. As used herein the term “carrier (carrier layer)” refers to a base material (support) which is applied together with the pressure-sensitive adhesive layer to an adherend when the optical pressure-sensitive adhesive sheet according to the embodiment of the present invention is used for (applied to) the adherend. The term “carrier” excludes a separator (release liner) which is removed before use (application) of the pressure-sensitive adhesive sheet.

Pressure-Sensitive Adhesive Layer for Use in Present Invention

The pressure-sensitive adhesive layer for use in the present invention may have an extracted acrylic acid ion amount of, per gram of the pressure-sensitive adhesive layer, equal to or less than 5 μg/g (e.g., 0 to 5 μg/g), preferably equal to or less than 4.5 μg/g (e.g., 0 to 4.5 μg/g), more preferably equal to or less than 4 μg/g (e.g., 0 to 4 μg/g), furthermore preferably equal to or less than 3.2 μg/g (e.g., 0 to 3.2 μg/g), particularly preferably equal to or less than 3 μg/g (e.g., 0 to 3 μg/g), and most preferably equal to or less than 2.5 μg/g (e.g., 0 to 2.5 μg/g). The term “extracted acrylic acid ion amount” refers to the amount of acrylic acid ions extracted from the pressure-sensitive adhesive layer with pure water at 100° C. for 45 minutes, where the amount is measured by ion chromatography (ion chromatographic technique). The extracted acrylic acid ion amount indicates the degree of how easily acrylic acid ions are liberated from the pressure-sensitive adhesive layer via water when the pressure-sensitive adhesive sheet is placed typically in a high-humidity (humidified) environment. Assume that the pressure-sensitive adhesive sheet is applied so that the pressure-sensitive adhesive layer for use in the present invention is affixed to an optical element at which a silver nanowire layer is present, and that the resulting article is stored in the presence of water, such as under high-humidity conditions. In this case, if the extracted acrylic acid ion amount is more than 5 μg/g, the pressure-sensitive adhesive layer liberate a large amount of acrylic acid ions which may corrode the silver nanowire layer. The resulting optical product including the corroded silver nanowire layer may readily have an increased resistance and decreased conductivity.

The “extracted acrylic acid ion amount” may be measured in the following manner.

Initially, the sample pressure-sensitive adhesive layer is cut to an appropriate size, one adhesive face of which is applied to a PET film (25 to 50 μm thick), but the other adhesive face alone is left exposed, to give a test specimen. Assume that the optical pressure-sensitive adhesive sheet according to the embodiment of the present invention is a carrier-supported single-sided pressure-sensitive adhesive sheet. In this case, the test specimen may be, as needed, the pressure-sensitive adhesive sheet from which a release liner has been removed. Also assume that the optical pressure-sensitive adhesive sheet according to the embodiment of the present invention is a double-sided pressure-sensitive adhesive transfer sheet including one pressure-sensitive adhesive layer. In this case, the test specimen may be the pressure-sensitive adhesive sheet bearing a release liner disposed on one side of the pressure-sensitive adhesive layer. The test specimen may have an exposed adhesive face area of 100 cm².

Next, the test specimen is placed in pure water at a temperature of 100° C. and boiled for 45 minutes to perform boiling extraction of acrylic acid ions and to give an extract.

Next, the amount (in microgram (μg)) of acrylic acid ions in the above-obtained extract is measured by ion chromatography. Based on this, the amount (in microgram per gram (μg/g)) of acrylic acid ions per gram of the pressure-sensitive adhesive layer in the test specimen is calculated. The ion chromatographic measurement may be performed under any conditions not limited, but may be performed under measurement conditions as follows.

Ion Chromatographic Measurement Conditions

Analyzer: ICS-3000, supplied by Thermo Fisher Scientific Inc.;

Separation column: Ion Pac AS18 (4 mm by 250 mm);

Guard column: Ion Pac AG18 (4 mm by 50 mm);

Suppressor system: AERS-500 (external mode);

Detector: conductivity detector;

Eluent: KOH aqueous solution, using Eluent Generator EG III);

Eluent flow rate: 1.0 ml/min.; and

Sample injection volume: 250 μl.

Examples of the pressure-sensitive adhesive constituting the pressure-sensitive adhesive layer for use in the present invention include, but are not limited to, acrylic pressure-sensitive adhesives, rubber pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, fluorine-containing pressure-sensitive adhesives, and epoxy pressure-sensitive adhesives. Among them, the pressure-sensitive adhesive constituting the pressure-sensitive adhesive layer is preferably selected from acrylic pressure-sensitive adhesives. The acrylic pressure-sensitive adhesives are preferred in points of transparency, tackiness, weatherability, cost, and easiness in designing of the pressure-sensitive adhesive. Specifically, the pressure-sensitive adhesive layer for use in the present invention is preferably an acrylic pressure-sensitive adhesive layer including an acrylic pressure-sensitive adhesive. The pressure-sensitive adhesive layer may include each of different pressure-sensitive adhesives alone or in combination.

The acrylic pressure-sensitive adhesive layer contains a base polymer including an acrylic polymer. The acrylic polymer is a polymer derived from at least one monomer component including an acrylic monomer. The acrylic monomer refers to a monomer containing a (meth)acryloyl group in molecule. The acrylic polymer is preferably a polymer derived from at least one monomer component including a (meth)acrylic alkyl ester. The acrylic pressure-sensitive adhesive layer may contain each of different acrylic polymers alone or in combination.

The pressure-sensitive adhesive layer for use in the present invention may be formed from (derived from) a pressure-sensitive adhesive composition in any form. Examples of the pressure-sensitive adhesive composition include, but are not limited to, compositions in emulsion form, solvent-borne compositions (compositions in solution form), active-energy-ray-curable compositions, and hot-melt compositions. Among them, preferred are solvent-borne pressure-sensitive adhesive compositions and active-energy-ray-curable pressure-sensitive adhesive compositions, because these pressure-sensitive adhesive compositions offer good productivity and may readily allow the resulting pressure-sensitive adhesive layer to have optical properties and appearance at excellent levels. In particular, the solvent-borne pressure-sensitive adhesive compositions are preferred from the viewpoint of reducing the amount of acrylic acid ions in the pressure-sensitive adhesive layer.

Specifically, the pressure-sensitive adhesive layer for use in the present invention is preferably an acrylic pressure-sensitive adhesive layer that contains an acrylic polymer as a base polymer and is derived from (formed from) a solvent-borne acrylic pressure-sensitive adhesive composition.

The active energy rays include, but are not limited to, ionizing radiation such as alpha rays, beta rays, gamma rays, neutron beams, and electron beams; and ultraviolet rays, of which ultraviolet rays are preferred. Specifically, of the active-energy-ray-curable pressure-sensitive adhesive compositions, preferred is an ultraviolet-curable pressure-sensitive adhesive composition.

Examples of the pressure-sensitive adhesive composition (acrylic pressure-sensitive adhesive composition) to form the acrylic pressure-sensitive adhesive layer include, but are not limited to, acrylic pressure-sensitive adhesive compositions each including an acrylic polymer as an essential component; and acrylic pressure-sensitive adhesive compositions each including a monomer mixture or a partially polymerized product of the monomer mixture as an essential component, where the monomer mixture is a mixture containing a monomer or monomers to constitute the acrylic polymer. Examples of the former compositions include, but are not limited to, so-called solvent-borne acrylic pressure-sensitive adhesive compositions. Examples of the latter compositions include, but are not limited to, so-called active-energy-ray-curable acrylic pressure-sensitive adhesive compositions. As used herein the term “monomer mixture” refers to a mixture containing a monomer component or components to constitute the polymer. The “partially polymerized product” is also referred to as a “prepolymer” and refers to a composition in which one or more of monomer component(s) in the monomer mixture are partially polymerized.

The acrylic polymer is a polymer derived from (formed from) a monomer component or components essentially including an acrylic monomer. The acrylic polymer is preferably a polymer derived from monomer component or components essentially including a (meth)acrylic alkyl ester. Specifically, the acrylic polymer preferably includes a constitutional unit derived from a (meth)acrylic alkyl ester. As used herein the term “(meth)acryl(ic)” refers to “acryl(ic)” and/or “methacryl(ic)”, i.e., refers to either one or both of “acryl(ic)” and “methacryl(ic)”. This is true for other descriptions. The acrylic polymer is derived from one monomer component, or two or more monomer components.

Preferred examples of the (meth)acrylic alkyl ester as the essential monomer component include (meth)acrylic alkyl esters containing a straight- or branched-chain alkyl group. Each of different (meth)acrylic alkyl esters may be used alone or in combination to constitute the acrylic polymer.

Examples of the (meth)acrylic alkyl esters containing a straight- or branched-chain alkyl group include, but are not limited to, (meth)acrylic alkyl esters containing a C₁-C₂₀ straight- or branched-chain alkyl group, such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate (stearyl (meth)acrylate), isostearyl (meth)acrylate, nonadecyl (meth)acrylate, and icosyl (meth)acrylate. Of the (meth)acrylic alkyl esters containing a straight- or branched-chain alkyl group, preferred are (meth)acrylic alkyl esters containing a C₄-C₁₈ straight- or branched-chain alkyl group, of which 2-ethylhexyl acrylate (2EHA) and isostearyl acrylate (ISTA) are more preferred. Each of different (meth)acrylic alkyl esters containing a straight- or branched-chain alkyl group may be used alone or in combination.

The monomer component(s) to constitute the acrylic polymer may contain the (meth)acrylic alkyl ester in a content not limited, but preferably equal to or more than 50 percent by weight (e.g., 50 to 100 percent by weight), more preferably 53 to 90 percent by weight, and furthermore preferably 55 to 85 percent by weight, based on the total weight (100 percent by weight) of all the monomer components.

The acrylic polymer may be derived from constitutive monomer components further including a copolymerizable monomer in addition to (in combination with) the (meth)acrylic alkyl ester. Specifically, the acrylic polymer may include a constitutional unit derived from a copolymerizable monomer. Each of different copolymerizable monomers may be used alone or in combination.

The copolymerizable monomer is not limited, but is preferably exemplified by a monomer containing a nitrogen atom in the molecule; and a monomer containing a hydroxy group in the molecule. These monomers are preferred for less clouding and better durability in a high-humidity environment, for good bonding reliability with respect to the silver nanowire layer and an after-mentioned protective layer, for good compatibility with the ultraviolet absorber and any other additives, and for satisfactory transparency. Specifically, the acrylic polymer preferably includes a constitutional unit derived from a monomer containing a nitrogen atom in the molecule. In addition or alternatively, the acrylic polymer preferably includes a constitutional unit derived from a monomer containing a hydroxy group in the molecule.

The monomer containing a nitrogen atom in the molecule is a monomer containing at least one nitrogen atom in the molecule (per molecule). The “monomer containing a nitrogen atom in the molecule” herein is also referred to as a “nitrogen-containing monomer(s)”. The nitrogen-containing monomer is preferably, but not limitatively, selected from cyclic nitrogen-containing monomers and (meth)acrylamides. Each of different nitrogen-containing monomers may be used alone or in combination.

The cyclic nitrogen-containing monomers are not limited, as long as ones that contain a polymerizable functional group (e.g., (meth)acryloyl group and/or vinyl group) including an unsaturated double bond and have a cyclic nitrogen structure. The cyclic nitrogen structure is preferably one containing a nitrogen atom within the cyclic structure.

Examples of the cyclic nitrogen-containing monomer include, but are not limited to, N-vinyl cyclic amides (lactam vinyl monomers) and vinyl monomers having a nitrogen-containing heterocycle.

Examples of the N-vinyl cyclic amides include, but are not limited to, N-vinyl cyclic amides represented by Formula (1):

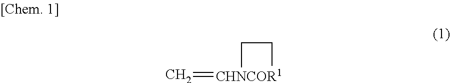

where R¹ represents a divalent organic group.

The group R¹ in Formula (1) is a divalent organic group, preferably a divalent saturated hydrocarbon group or unsaturated hydrocarbon group, and more preferably a divalent saturated hydrocarbon group (e.g., a C₃-C₅ alkylene group).

Examples of the N-vinyl cyclic amides represented by Formula (1) include, but are not limited to, N-vinyl-2-pyrrolidone, N-vinyl-2-piperidone, N-vinyl-3-morpholinone, N-vinyl-2-caprolactam, N-vinyl-1,3-oxazin-2-one, and N-vinyl-3,5-morpholinedione.

The vinyl monomers having a nitrogen-containing heterocycle are exemplified by, but are not limited to, acrylic monomers having a nitrogen-containing heterocycle such as morpholine ring, piperidine ring, pyrrolidine ring, and/or piperazine ring.

Examples of the vinyl monomers having a nitrogen-containing heterocycle include, but are not limited to, (meth)acryloylmorpholine, N-vinylpiperazine, N-vinylpyrrole, N-vinylimidazole, N-vinylpyrazine, N-vinylmorpholine, N-vinylpyrazole, vinylpyridines, vinylpyrimidines, vinyloxazoles, vinylisoxazoles, vinylthiazoles, vinylisothiazoles, vinylpyridazines, (meth)acryloylpyrrolidones, (meth)acryloylpyrrolidines, and (meth)acryloylpiperidines.

Of the vinyl monomers having a nitrogen-containing heterocycle, acrylic monomers having a nitrogen-containing heterocycle are preferred, of which (meth)acryloylmorpholines, (meth)acryloylpyrrolidines, and (meth)acryloylpiperidines are more preferred.

Examples of the (meth)acrylamides include, but are not limited to, (meth)acrylamide, N-alkyl(meth)acrylamides, and N,N-dialkyl(meth)acrylamides. Examples of the N-alkyl(meth)acrylamides include, but are not limited to, N-ethyl(meth)acrylamide, N-isopropyl(meth)acrylamide, N-n-butyl(meth)acrylamide, and N-octyl(meth)acrylamide. Examples of the N-alkyl(meth)acrylamides further include amino-containing (meth)acrylamides such as dimethylaminoethyl(meth)acrylamide, diethylaminoethyl(meth)acrylamide, and dimethylaminopropyl(meth)acrylamide. Examples of the N,N-dialkyl(meth)acrylamides include, but are not limited to, N,N-dimethyl(meth)acrylamide, N,N-diethyl(meth)acrylamide, N,N-dipropyl(meth)acrylamide, N,N-diisopropyl(meth)acrylamide, N,N-di(n-butyl) (meth)acrylamide, and N,N-di(t-butyl) (meth)acrylamide.

Examples of the (meth)acrylamides further include various N-hydroxyalkyl(meth)acrylamides. Examples of the N-hydroxyalkyl(meth)acrylamides include, but are not limited to, N-methylol(meth)acrylamide, N-(2-hydroxyethyl) (meth)acrylamide, N-(2-hydroxypropyl) (meth)acrylamide, N-(1-hydroxypropyl) (meth)acrylamide, N-(3-hydroxypropyl) (meth)acrylamide, N-(2-hydroxybutyl) (meth)acrylamide, N-(3-hydroxybutyl) (meth)acrylamide, N-(4-hydroxybutyl) (meth)acrylamide, and N-methyl-N-2-hydroxyethyl(meth)acrylamide.

Examples of the (meth)acrylamides further include various N-alkoxyalkyl(meth)acrylamides. Non-limiting examples of the N-alkoxyalkyl(meth)acrylamides include N-methoxymethyl(meth)acrylamide and N-butoxymethyl(meth)acrylamide.

In addition to the cyclic nitrogen-containing monomers and the (meth)acrylamides, examples of the nitrogen-containing monomers further include amino-containing monomers, cyano-containing monomers, imido-containing monomers, and isocyanato-containing monomers. Examples of the amino-containing monomer include, but are not limited to, aminoethyl (meth)acrylate, dimethylaminoethyl (meth)acrylate, dimethylaminopropyl (meth)acrylate, and t-butylaminoethyl (meth)acrylate. Examples of the cyano-containing monomers include, but are not limited to, acrylonitrile and methacrylonitrile. Examples of the imido-containing monomers include, but are not limited to, maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-laurylitaconimide, and N-cyclohexylitaconimide; and succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide. A non-limiting example of the isocyanato-containing monomers is 2-(meth)acryloyloxyethyl isocyanate.

Of the nitrogen-containing monomers, cyclic nitrogen-containing monomers are preferred, of which N-vinyl cyclic amides are more preferred. More specifically, N-vinyl-2-pyrrolidone (NVP) is particularly preferred.

Assume that the acrylic polymer is derived from constitutive monomer components including the nitrogen-containing monomer. In this case, the proportion of the nitrogen-containing monomer is not limited, but preferably equal to or more than 1 percent by weight, more preferably equal to or more than 3 percent by weight, and furthermore preferably equal to or more than 5 percent by weight, of all the monomer components (100 percent by weight) to constitute the acrylic polymer. Advantageously, with the nitrogen-containing monomer in a proportion of equal to or more than 1 percent by weight, the proportion of the monomer containing a hydroxy group in the molecule can be reduced, and thereby the amount of acrylic acid ions derived from the monomer containing a hydroxy group in the molecule may tend to be further reduced. In addition and advantageously, the above-mentioned configuration may provide less clouding and better durability in a high-humidity environment and may offer better bonding reliability with respect to the silver nanowire layer and/or the protective layer. In terms of upper limit, the proportion of the nitrogen-containing monomer is preferably equal to or less than 30 percent by weight, more preferably equal to or less than 25 percent by weight, and furthermore preferably equal to or less than 20 percent by weight. This is preferred to allow the pressure-sensitive adhesive layer to have appropriate flexibility and excellent transparency.

The monomer containing a hydroxy group in the molecule is a monomer containing at least one hydroxy group in the molecule (per molecule) and is preferably exemplified by monomers that contain a (meth)acryloyl group, a vinyl group, and/or another polymerizable functional group having an unsaturated double bond and still contain a hydroxy group. The monomers containing a hydroxy group in the molecule exclude the nitrogen-containing monomers. Specifically, in the description, monomers containing both a nitrogen atom and a hydroxy group in the molecule are included in the “nitrogen-containing monomers”. The “monomer(s) containing a hydroxy group in the molecule” is herein also referred to as a “hydroxy-containing monomer(s)”. Each of different hydroxy-containing monomers may be used alone or in combination.

Examples of the hydroxy-containing monomer include, but are not limited to, hydroxy-containing (meth)acrylic esters such as 2-hydroxyethyl (meth)acrylate, 2-hydroxypropyl (meth)acrylate, 3-hydroxypropyl (meth)acrylate, 4-hydroxybutyl (meth)acrylate, 6-hydroxyhexyl (meth)acrylate, hydroxyoctyl (meth)acrylate, hydroxydecyl (meth)acrylate, hydroxylauryl (meth)acrylate, and (4-hydroxymethylcyclohexyl) (meth)acrylate; vinyl alcohol; and allyl alcohol.

Of the hydroxy-containing monomers, hydroxy-containing (meth)acrylic esters are preferred, of which 2-hydroxyethyl acrylate (HEA) and 4-hydroxybutyl acrylate (4HBA) are more preferred.

Assume that the acrylic polymer is derived from constitutive monomer components including the hydroxy-containing monomer. In this case, the proportion of the hydroxy-containing monomer is not limited, but preferably equal to or more than 0.5 percent by weight, more preferably equal to or more than 0.8 percent by weight, and furthermore preferably equal to or more than 1 percent by weight, of all the monomer components (100 percent by weight) to constitute the acrylic polymer. This is preferred for less clouding and better durability in a high-humidity environment and for better bonding reliability with respect to the silver nanowire layer and/or the protective layer. In terms of upper limit, the proportion of the hydroxy-containing monomer is preferably equal to or less than 30 percent by weight, more preferably equal to or less than 25 percent by weight, and furthermore preferably equal to or less than 15 percent by weight. Advantageously, with the hydroxy-containing monomer in a proportion of equal to or less than 30 percent by weight (in particular, equal to or less than 25 percent by weight), the amount of acrylic acid ions derived from the hydroxy-containing monomer may tend to be further reduced. The acrylic acid ions derived from such a hydroxy-containing monomer are supposed to be mixed in the polymer when the polymer is derived from constitutive monomer components including the hydroxy-containing monomer. This is probably because acrylic acid ions are mixed during the production process of the hydroxy-containing monomer, and the resulting commercial product contains, as impurities, the acrylic acid ions in a certain proportion. Assume that the pressure-sensitive adhesive layer for use in the present invention is formed from an active-energy-ray-curable pressure-sensitive adhesive composition. In this case, the proportion of the hydroxy-containing monomer in terms of upper limit is preferably equal to or less than 10 percent by weight, and more preferably equal to or less than 5 percent by weight, of all the monomer components (100 percent by weight) to constitute the acrylic polymer. This is preferred from the viewpoint of further reduction of the acrylic acid ion amount in the pressure-sensitive adhesive layer.

The total of proportions of the nitrogen-containing monomer and the hydroxy-containing monomer is not limited, but preferably equal to or more than 5 percent by weight, more preferably equal to or more than 10 percent by weight, and furthermore preferably equal to or more than 15 percent by weight, of all the monomer components (100 percent by weight) to constitute the acrylic polymer. This is preferred for less clouding and better durability in a high-humidity environment and for better bonding reliability with respect to the silver nanowire layer and/or the protective layer. The total of proportions in terms of upper limit is preferably equal to or less than 50 percent by weight, more preferably equal to or less than 40 percent by weight, and furthermore preferably equal to or less than 35 percent by weight. This is preferred for allowing the pressure-sensitive adhesive layer to have appropriate flexibility and excellent transparency.

In addition to the nitrogen-containing monomers and hydroxy-containing monomers, examples of the copolymerizable monomers further include alicyclic-structure-containing monomers. The alicyclic-structure-containing monomers are not limited, as long as ones that contain a polymerizable functional group (e.g., (meth)acryloyl group and/or vinyl group) having an unsaturated double bond and have an alicyclic structure. For example, alkyl (meth)acrylates containing a cycloalkyl group are included in the alicyclic-structure-containing monomers. Each of different alicyclic-structure-containing monomers may be used alone or in combination.

The alicyclic structure in the alicyclic-structure-containing monomers is a cyclic hydrocarbon structure and may contain carbon atoms in a number of preferably equal to or more than 5, more preferably 6 to 24, furthermore preferably 6 to 15, and particularly preferably 6 to 10.

Examples of the alicyclic-structure-containing monomers include, but are not limited to, (meth)acrylic monomers such as cyclopropyl (meth)acrylate, cyclobutyl (meth)acrylate, cyclopentyl (meth)acrylate, cyclohexyl (meth)acrylate, cycloheptyl (meth)acrylate, cyclooctyl (meth)acrylate, isobornyl (meth)acrylate, dicyclopentanyl (meth)acrylate, HPMPA represented by Formula (2), TMA-2 represented by Formula (3), and HCPA represented by Formula (4) below. In Formula (4), the bonding site indicated by a line between the cyclohexyl ring and the structure in the parentheses is not limited. Among them, isobornyl (meth)acrylate is preferred.

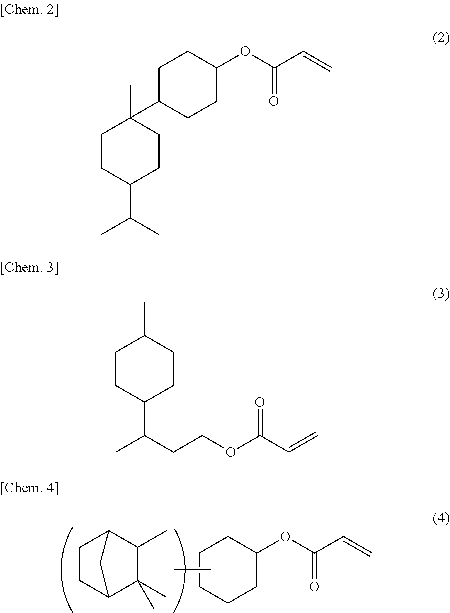

Assume that the acrylic polymer is derived from constitutive monomer components including the alicyclic-structure-containing monomer. In this case, the proportion of the alicyclic-structure-containing monomer is not limited, but preferably equal to or more than 10 percent by weight of all the monomer components (100 percent by weight) to constitute the acrylic polymer. This is preferred for better durability and for better bonding reliability with respect to the silver nanowire layer and/or the protective layer. The proportion of the alicyclic-structure-containing monomer in terms of upper limit is preferably equal to or less than 50 percent by weight, more preferably equal to or less than 40 percent by weight, and furthermore preferably equal to or less than 30 percent by weight. This is preferred for allowing the pressure-sensitive adhesive layer to have appropriate flexibility.

Examples of the copolymerizable monomers further include multifunctional monomers. Examples of the multifunctional monomers include, but are not limited to, hexanediol di(meth)acrylate, butanediol di(meth)acrylate, (poly)ethylene glycol di(meth)acrylate, (poly) propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzenes, epoxy acrylates, polyester acrylates, and urethane acrylates. Each of different multifunctional monomers may be used alone or in combination.

Assume that the acrylic polymer is derived from constitutive monomer components including the multifunctional monomer. In this case, the proportion of the multifunctional monomer is not limited, but preferably equal to or less than 0.5 percent by weight (e.g., from greater than 0 percent by weight to 0.5 percent by weight), and more preferably equal to or less than 0.2 percent by weight (e.g., from greater than 0 percent by weigh to 0.2 percent by weight), of all the monomer components (100 percent by weight) to constitute the acrylic polymer.

Examples of the copolymerizable monomers further include (meth)acrylic alkoxyalkyl esters. Examples of the (meth)acrylic alkoxyalkyl esters include, but are not limited to, 2-methoxyethyl (meth)acrylate, 2-ethyoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate, and 4-ethoxybutyl (meth)acrylate. Of the (meth)acrylic alkoxyalkyl esters, acrylic alkoxyalkyl esters are preferred, of which 2-methoxyethyl acrylate (MEA) is more preferred. Each of different (meth)acrylic alkoxyalkyl esters may be used alone or in combination.

Assume that the acrylic polymer is derived from constitutive monomer components including the (meth)acrylic alkoxyalkyl ester. In this case, the ratio (weight ratio) of the (meth)acrylic alkyl ester to the (meth)acrylic alkoxyalkyl ester is not limited, but preferably from 25:75 to less than 100:0, and more preferably from 50:50 to less than 100:0.

In addition, examples of the copolymerizable monomers further include carboxy-containing monomers, epoxy-containing monomers, sulfonate-containing monomers, phosphate-containing monomers, (meth)acrylic esters containing an aromatic hydrocarbon group, vinyl esters, aromatic vinyl compounds, olefins or dienes, vinyl ethers, and vinyl chloride. Examples of the carboxy-containing monomers include, but are not limited to, (meth)acrylic acid, itaconic acid, maleic acid, fumaric acid, crotonic acid, and isocrotonic acid. The carboxy-containing monomers herein also include acid-anhydride-containing monomers such as maleic anhydride and itaconic anhydride. Examples of the epoxy-containing monomers include, but are not limited to, glycidyl (meth)acrylate and methylglycidyl (meth)acrylate. A non-limiting example of the sulfonate-containing monomers is sodium vinylsulfonate. Examples of the (meth)acrylic esters containing an aromatic hydrocarbon group include, but are not limited to, phenyl (meth)acrylate, phenoxyethyl (meth)acrylate, and benzyl (meth)acrylate. Examples of the vinyl esters include, but are not limited to, vinyl acetate and vinyl propionate. Examples of the aromatic vinyl compounds include, but are not limited to, styrene and vinyltoluenes. Examples of the olefins or dienes include, but are not limited to, ethylene, propylene, butadiene, isoprene, and isobutylene. Examples of the vinyl ethers include, but are not limited to, vinyl alkyl ethers.

The acrylic polymer is preferably derived from constitutive monomer components devoid of or approximately devoid of acidic-group-containing monomers and is particularly preferably derived from constitutive monomer components devoid of or approximately devoid of carboxy-containing monomers. This is preferred for allowing the acrylic pressure-sensitive adhesive layer to have excellent non-corrosivity with respect to the silver nanowire layer. Examples of the acidic-group-containing monomers include, but are not limited to, carboxy-containing monomers, sulfonate-containing monomers, and phosphate-containing monomers. Specifically, monomer components to constitute the acrylic polymer, when having a proportion of acidic-group-containing monomers of equal to or less than 0.05 percent by weight (preferably equal to or less than 0.01 percent by weight) of all the monomer components (100 percent by weight), may be considered to be approximately devoid of acidic-group-containing monomers.

The acrylic polymer is preferably, but not limitatively, derived from constitutive monomer components including a high-Tg monomer. The “high-Tg monomer” refers to such a monomer as to give a homopolymer having a high glass transition temperature (Tg). The acrylic polymer, when derived from constitutive monomer components including the high-Tg monomer, may allow the pressure-sensitive adhesive containing the acrylic polymer to become hard and may allow the optical pressure-sensitive adhesive sheet according to the embodiment of the present invention to have still better bonding reliability at high temperatures with respect to the silver nanowire layer and/or the protective layer.

The homopolymer formed from the high-Tg monomer may have a glass transition temperature not limited, but typically equal to or higher than 20° C., preferably equal to or higher than 30° C., and more preferably equal to or higher than 90° C. The high-Tg monomer, when having a glass transition temperature Tg within the range, may allow the pressure-sensitive adhesive layer to have higher cohesive force.

The high-Tg monomer may be selected from the monomers exemplified by monomers to be contained in the monomer components to constitute the acrylic polymer; or from any other monomers. In particular, the monomer components to constitute the acrylic polymer preferably include a monomer component that is selected from the monomers exemplified as monomer components to constitute the acrylic polymer and is a high-Tg monomer. The monomer components to constitute the acrylic polymer may include each of different high-Tg monomers alone or in combination.

Examples of the high-Tg monomers include, but are not limited to, methyl methacrylate (Tg: 105° C.), ethyl methacrylate (Tg: 65° C.), cyclohexyl methacrylate (Tg: 83° C.), isobornyl acrylate (Tg: 94° C.), isobornyl methacrylate (Tg: 150° C.), benzyl methacrylate (Tg: 54° C.), glycidyl methacrylate (Tg: 46° C.), stearyl methacrylate (Tg: 38° C.), 3-hydroxypropyl methacrylate (Tg: 26° C.), 2-hydroxyethyl methacrylate (Tg: 55° C.), acrylic acid (Tg: 106° C.), and methacrylic acid (Tg: 227° C.). In addition to the above, examples of the high-Tg monomers further include, but are not limited to, vinyl acetate (Tg: 32° C.), acrylonitrile (Tg: 97° C.), methacrylonitrile (Tg: 120° C.), styrene (Tg: 80° C.), 2-methylstyrene (Tg: 136° C.), acrylamide (Tg: 165° C.), and N-vinyl-2-pyrrolidone (NVP) (Tg: 80° C.). Among them, methyl methacrylate, isobornyl acrylate, and NVP are preferred.

Assume that the acrylic polymer is derived from constitutive monomer components including the high-Tg monomer. In this case, the proportion of the high-Tg monomer is not limited, but preferably 1 to 50 percent by weight, more preferably 5 to 40 percent by weight, and furthermore preferably 10 to 30 percent by weight, of all the monomer components (100 percent by weight) to constitute the acrylic polymer. The acrylic polymer, when derived from constitutive monomer components including the high-Tg monomer in a proportion within the range, may allow the optical pressure-sensitive adhesive sheet according to the embodiment of the present invention to have still better bonding reliability at high temperatures with respect to the silver nanowire layer and/or the protective layer. When the monomer components to constitute the acrylic polymer include two or more different high-Tg monomers, the “proportion of the high-Tg monomer” refers to the total of proportions of the two or more different high-Tg monomers.

In particular, the acrylic polymer is preferably an acrylic polymer derived from a monomer mixture including 50 to 90 percent by weight (preferably 55 to 85 percent by weight) of a (meth)acrylic alkyl ester containing a C₄-C₁₈ straight- or branched-chain alkyl group, 10 to 50 percent by weight (preferably 15 to 40 percent by weight) of at least one monomer selected from the group consisting of nitrogen-containing monomers and hydroxy-containing monomers, and 0 to 40 percent by weight (preferably 0 to 30 percent by weight) of a monomer having a C₆-C₁₀ alicyclic structure. The acrylic polymer is more preferably an acrylic polymer derived from a monomer mixture including 50 to 90 percent by weight (preferably 55 to 85 percent by weight) of a (meth)acrylic alkyl ester containing a C₄-C₁₈ straight- or branched-chain alkyl group, 3 to 30 percent by weight (preferably 5 to 25 percent by weight) of a nitrogen-containing monomer, 0.8 to 25 percent by weight (preferably 1 to 15 percent by weight) of a hydroxy-containing monomer, and 0 to 40 percent by weight (preferably 0 to 30 percent by weight) of a monomer having a C₆-C₁₀ alicyclic structure, in which the total of proportions of the nitrogen-containing monomer and the hydroxy-containing monomer is 10 to 50 percent by weight (preferably 15 to 40 percent by weight). The proportions (in weight percent) are proportions based on all the monomer components (100 percent by weight) to constitute the acrylic polymer.

The pressure-sensitive adhesive layer for use in the present invention may contain the base polymer (in particular, the acrylic polymer) in a content not limited, but preferably equal to or more than 50 percent by weight (e.g., 50 to 100 percent by weight), more preferably equal to or more than 80 percent by weight (e.g., 80 to 100 percent by weight), and furthermore preferably equal to or more than 90 percent by weight (e.g., 90 to 100 percent by weight), based on the total weight (100 percent by weight) of the pressure-sensitive adhesive layer for use in the present invention.

The base polymer, such as the acrylic polymer, contained in the pressure-sensitive adhesive layer for use in the present invention may be obtained by polymerizing one or more monomer components. Examples of the polymerization technique include, but are not limited to, solution polymerization, emulsion polymerization, bulk polymerization, and polymerization via active energy ray irradiation (active-energy-ray-polymerization). Among them, preferred are solution polymerization and active-energy-ray-polymerization in points typically of pressure-sensitive adhesive layer transparency and cost; of which solution polymerization is more preferred from the viewpoint of further reduction in acrylic acid ion amount in the pressure-sensitive adhesive layer.

The monomer component polymerization may be performed using any of common solvents. Examples of the solvents include, but are not limited to, organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. Each of different solvents may be used alone or in combination.

The monomer component polymerization may be performed using any of polymerization initiators such as thermal initiators and photoinitiators (photopolymerization initiators) selected according to the polymerization reaction type. Each of different polymerization initiators may be used alone or in combination.

Examples of the thermal initiators include, but are not limited to, azo polymerization initiators; peroxide polymerization initiators such as dibenzoyl peroxide and tert-butyl permaleate; and redox polymerization initiators. Among them, the azo polymerization initiators disclosed in JP-A No. 2002-69411 are preferred. Examples of the azo polymerization initiators include, but are not limited to, 2,2′-azobisisobutyronitrile (hereinafter also referred to as “AIBN”), 2,2′-azobis-2-methylbutyronitrile (hereinafter also referred to as “AMBN”), dimethyl 2,2′-azobis(2-methylpropionate), and 4,4′-azobis(4-cyanovaleric acid). Each of different thermal initiators may be used alone or in combination.

Assume that the polymerization to form the acrylic polymer is performed using the azo polymerization initiator. In this case, the azo polymerization initiator may be used in an amount not limited, but preferably equal to or more than 0.05 part by weight and more preferably equal to or more than 0.1 part by weight, and preferably equal to or less than 0.5 part by weight and more preferably equal to or less than 0.3 part by weight, per 100 parts by weight of all the monomer components to constitute the acrylic polymer.

Examples of the photoinitiators include, but are not limited to, benzoin ether photoinitiators, acetophenone photoinitiators, α-ketol photoinitiators, aromatic sulfonyl chloride photoinitiators, photoactive oxime photoinitiators, benzoin photoinitiators, benzil photoinitiators, benzophenone photoinitiators, ketal photoinitiators, and thioxanthone photoinitiators; as well as acylphosphine oxide photoinitiators, and titanocene photoinitiators. Examples of the benzoin ether photoinitiators include, but are not limited to, benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Examples of the acetophenone photoinitiators include, but are not limited to, 2,2-diethoxyacetophenone, 2,2-dimethoxy-2-phenylacetophenone, 1-hydroxycyclohexyl phenyl ketone, 4-phenoxydichloroacetophenone, and 4-(t-butyl)dichloroacetophenone. Examples of the α-ketol photoinitiators include, but are not limited to, 2-methyl-2-hydroxypropiophenone and 1-[4-(2-hydroxyethyl)phenyl]-2-methylpropan-1-one. A non-limiting example of the aromatic sulfonyl chloride photoinitiators is 2-naphthalenesulfonyl chloride. A non-limiting example of the photoactive oxime photoinitiators is 1-phenyl-1,1-propanedione-2-(O-ethoxycarbonyl)oxime. A non-limiting example of the benzoin photoinitiators is benzoin. A non-limiting example of the benzil photoinitiators is benzil (1,2-diphenylethane-1,2-dione). Examples of the benzophenone photoinitiators include, but are not limited to, benzophenone, benzoylbenzoic acid, 3,3′-dimethyl-4-methoxybenzophenone, polyvinylbenzophenones, and α-hydroxycyclohexyl phenyl ketone. A non-limiting example of the ketal photoinitiators is benzil dimethyl ketal. Examples of the thioxanthone photoinitiators include, but are not limited to, thioxanthone, 2-chlorothioxanthone, 2-methylthioxanthone, 2,4-dimethylthioxanthone, isopropylthioxanthone, 2,4-diisopropylthioxanthone, and dodecylthioxanthone. Examples of the acylphosphine oxide photoinitiators include, but are not limited to, diphenyl(2,4,6-trimethylbenzoyl)phosphine oxide and phenylbis(2,4,6-trimethylbenzoyl)phosphine oxide. A non-limiting example of the titanocene photoinitiators is bis(η⁵-2,4-cyclopentadien-1-yl)-bis(2,6-difluoro-3-(1H-pyrrol-1-yl)-phenyl)titanium. Each of different photoinitiators may be used alone or in combination.

Assume that the polymerization to form the acrylic polymer is performed using the photoinitiator. In this case, the photoinitiator may be used in an amount not limited, but typically preferably equal to or more than 0.01 part by weight and more preferably equal to or more than 0.1 part by weight, and preferably equal to or less than 3 parts by weight and more preferably equal to or less than 1.5 parts by weight, per 100 parts by weight of all the monomer components to constitute the acrylic polymer.

The pressure-sensitive adhesive layer for use in the present invention preferably, but not limitatively, contains an ultraviolet absorber (UVA). The pressure-sensitive adhesive layer for use in the present invention, when containing the ultraviolet absorber, may tend to have a further smaller extracted acrylic acid ion amount. Assume that the pressure-sensitive adhesive layer for use in the present invention is an acrylic pressure-sensitive adhesive layer formed from or derived from a solvent-borne pressure-sensitive adhesive composition. In particular in this case, the acrylic pressure-sensitive adhesive layer preferably contains the ultraviolet absorber. The pressure-sensitive adhesive layer may contain each different ultraviolet absorbers alone or in combination.

Examples of the ultraviolet absorbers include, but are not limited to, benzotriazole ultraviolet absorbers, hydroxyphenyltriazine ultraviolet absorbers, benzophenone ultraviolet absorbers, salicylic acid ester ultraviolet absorbers, cyanoacrylate ultraviolet absorbers, and oxybenzophenone ultraviolet absorbers.

Examples of the benzotriazole ultraviolet absorbers (benzotriazole compounds) include, but are not limited to, 2-(2-hydroxy-5-tert-butylphenyl)-2H-benzotriazole (e.g., trade name Tinuvin PS, supplied by BASF SE); 3-(2H-benzotriazol-2-yl)-5-(1,1-dimethylethyl)-4-hydroxy-benzenepropanoic acid, C₇-C₉-branched and linear alkyl esters (e.g., trade name Tinuvin 384-2, supplied by BASF SE); mixtures of octyl 3-[3-tert-butyl-4-hydroxy-5-(5-chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate (e.g., trade name Tinuvin 109, supplied by BASF SE); 2-(2H-benzotriazol-2-yl)-4,6-bis(1-methyl-1-phenylethyl)phenol (e.g., trade name Tinuvin 900, supplied by BASF SE); 2-(2H-benzotriazol-2-yl)-6-(1-methyl-1-phenylethyl)-4-(1,1,3,3-tetramethylbutyl)phenol (e.g., trade name Tinuvin 928, supplied by BASF SE); reaction products of methyl 3-(3-(2H-benzotriazol-2-yl)-5-tert-butyl-4-hydroxyphenyl)propionate with poly(ethylene glycol) 300 (e.g., trade names Tinuvin 1130 and Tinuvin 213, supplied by BASF SE); 2-(2H-benzotriazol-2-yl)-p-cresol (e.g., trade name Tinuvin P, supplied by BASF SE); 2-(2H-benzotriazol-2-yl)-4,6-bis(1-methyl-1-phenylethyl)phenol (e.g., trade name Tinuvin 234, supplied by BASF SE); 2-[5-chloro-2H-benzotriazol-2-yl]-4-methyl-6-(tert-butyl)phenol (e.g., trade name Tinuvin 326, supplied by BASF SE); 2-(2H-benzotriazol-2-yl)-4,6-di-tert-pentylphenol (e.g., trade name Tinuvin 328, supplied by BASF SE); 2-(2H-benzotriazol-2-yl)-4-(1,1,3,3-tetramethylbutyl)phenol (e.g., trade name Tinuvin 329, supplied by BASF SE); 2,2′-methylenebis[6-(2H-benzotriazol-2-yl)-4-(1,1,3,3-tetramethylbutyl)phenol] (e.g., trade name Tinuvin 360, supplied by BASF SE); 2-(2H-benzotriazol-2-yl)-6-dodecyl-4-methylphenol (e.g., trade name Tinuvin 571, supplied by BASF SE); 2-[2-hydroxy-3-(3,4,5,6-tetrahydrophthalimido-methyl)-5-methylphenyl]benzotriazole (e.g., trade name Sumisorb 250, supplied by Sumitomo Chemical Co., Ltd.); and 2,2′-methylenebis[6-(2H-benzotriazol-2-yl)-4-tert-octylphenol] (e.g., trade name ADK STAB LA-31, supplied by ADEKA CORPORATION).

Examples of the hydroxyphenyltriazine ultraviolet absorbers (hydroxyphenyltriazine compounds) include, but are not limited to, reaction products of 2-(4,6-bis(2,4-dimethylphenyl)-1,3,5-triazin-2-yl)-5-hydroxyphenyl with [(C₁₀-C₁₆ (mainly C₁₂-C₁₃) alkyloxy)methyl]oxirane (e.g., trade name Tinuvin 400, supplied by BASF SE); 2-[4,6-bis(2,4-dimethylphenyl)-1,3,5-triazin-2-yl]-5-[3-(dodecyloxy)-2-hydroxypropoxy]phenol); reaction products of 2-(2,4-dihydroxyphenyl)-4,6-bis-(2,4-dimethylphenyl)-1,3,5-triazine with (2-ethylhexyl) glycidate (e.g., trade name Tinuvin 405, supplied by BASF SE); 2,4-bis(2-hydroxy-4-butoxyphenyl)-6-(2,4-dibutoxyphenyl)-1,3,5-triazine (e.g., trade name Tinuvin 460, supplied by BASF SE); 2-(4,6-diphenyl-1,3,5-triazin-2-yl)-5-[(hexyl)oxy]-phenol (e.g., trade name Tinuvin 1577, supplied by BASF SE); 2-(4,6-diphenyl-1,3,5-triazin-2-yl)-5-[2-(2-ethylhexanoyloxy)ethoxy]-phenol (e.g., trade name ADK STAB LA-46, supplied by ADEKA CORPORATION); and 2-(2-hydroxy-4-[1-octyloxycarbonylethoxy]phenyl)-4,6-bis(4-phenylphenyl)-1,3,5-triazine (e.g., trade name Tinuvin 479, supplied by BASF SE). Examples of the hydroxyphenyltriazine ultraviolet absorbers further include a compound represented by Formula (5) (e.g., trade name Tinuvin 477, supplied by BASF SE).

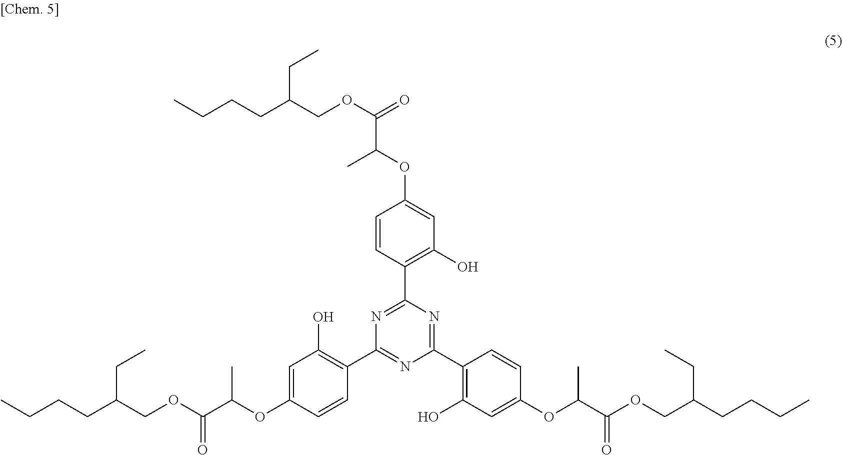 [SMILES: CCCCC(CC)COC(=O)C(C)Oc1ccc(-c2nc(-c3ccc(OC(C)C(=O)OCC(CC)CCCC)cc3O)nc(-c3ccc(OC(C)C(=O)OCC(CC)CCCC)cc3O)n2)c(O)c1]

Examples of the benzophenone ultraviolet absorbers (benzophenone compounds) and oxybenzophenone ultraviolet absorbers (oxybenzophenone compounds) include, but are not limited to, 2,4-dihydroxybenzophenone, 2-hydroxy-4-methoxybenzophenone, 2-hydroxy-4-methoxybenzophenone-5-sulfonic acid (anhydride and trihydrate), 2-hydroxy-4-octyloxybenzophenone, 4-dodecyloxy-2-hydroxybenzophenone, 4-benzyloxy-2-hydroxybenzophenone, 2,2′-dihydroxy-4-methoxybenzophenone (e.g., trade name KEMISORB 111, supplied by Chemipro Kasei Kaisha, Ltd.), 2,2′,4,4′-tetrahydroxybenzophenone (e.g., trade name SEESORB 106, supplied by Shipro Kasei Kaisha, Ltd.), and 2,2′-dihydroxy-4,4′-dimethoxybenzophenone.

Examples of the salicylic acid ester ultraviolet absorbers (salicylic acid ester compounds) include, but are not limited to, phenyl 2-acryloyloxybenzoate, phenyl 2-acryloyloxy-3-methylbenzoate, phenyl 2-acryloyloxy-4-methylbenzoate, phenyl 2-acryloyloxy-5-methylbenzoate, phenyl 2-acryloyloxy-3-methoxybenzoate, phenyl 2-hydroxybenzoate, phenyl 2-hydroxy-3-methylbenzoate, phenyl 2-hydroxy-4-methylbenzoate, phenyl 2-hydroxy-5-methylbenzoate, phenyl 2-hydroxy-3-methoxybenzoate, and 2,4-di-tert-butylphenyl 3,5-di-tert-butyl-4-hydroxybenzoate (e.g., trade name Tinuvin 120, supplied by BASF SE).

Examples of the cyanoacrylate ultraviolet absorbers (cyanoacrylate compounds) include, but are not limited to, alkyl 2-cyanoacrylates, cycloalkyl 2-cyanoacrylates, alkoxyalkyl 2-cyanoacrylates, alkenyl 2-cyanoacrylates, and alkynyl 2-cyanoacrylates.

The ultraviolet absorber for use in the pressure-sensitive adhesive layer is preferably at least one ultraviolet absorber selected from the group consisting of benzotriazole ultraviolet absorbers, benzophenone ultraviolet absorbers, and hydroxyphenyltriazine ultraviolet absorbers and is more preferably at least one ultraviolet absorber selected from the group consisting of benzotriazole ultraviolet absorbers and benzophenone ultraviolet absorbers. These ultraviolet absorbers are preferred because they have high ultraviolet absorptivity and still allow the resulting pressure-sensitive adhesive layer to have better non-corrosivity (in particular, UV-resistant non-corrosivity) with respect to the silver nanowire layer; they allow the pressure-sensitive adhesive layer to have excellent optical properties and high transparency; and they have excellent photostability. Among them, particularly preferred are benzotriazole ultraviolet absorbers that contain a phenyl group substituted with a hydroxy group and a group containing six or more carbon atoms, where the phenyl group is bonded to a nitrogen atom constituting the benzotriazole ring.

The ultraviolet absorber preferably has an absorbance A of equal to or less than 0.5, where the absorbance A is specified below. This is preferred for better ultraviolet absorptivity and better non-corrosivity (in particular, UV-resistant non-corrosivity) with respect to the silver nanowire layer.

The absorbance A is an absorbance of a 0.08% solution of the ultraviolet absorber in toluene and is measured upon application of light at a wavelength of 400 nm to the solution.

Assume that the pressure-sensitive adhesive layer for use in the present invention contains the ultraviolet absorber. In this case, the proportion of the ultraviolet absorber in the pressure-sensitive adhesive layer for use in the present invention (in particular, the acrylic pressure-sensitive adhesive layer) is not limited, but preferably equal to or more than 0.01 part by weigh, more preferably equal to or more than 0.05 part by weigh, and furthermore preferably equal to or more than 0.1 part by weight, per 100 parts by weight of the base polymer. This is preferred for further reduction in extracted acrylic acid ion amount. The proportion of the ultraviolet absorber in terms of upper limit is preferably equal to or less than 10 parts by weight, more preferably equal to or less than 9 parts by weight, and furthermore preferably equal to or less than 8 parts by weight, per 100 parts by weight of the base polymer. This is preferred for suppressing yellowing (a yellowing phenomenon) of the pressure-sensitive adhesive attended with the addition of the ultraviolet absorber and for offering excellent optical properties, high transparency, and excellent appearance properties.

The pressure-sensitive adhesive layer for use in the present invention may contain a photostabilizer. Assume that the pressure-sensitive adhesive layer for use in the present invention contains the photostabilizer. In particular in this case, the pressure-sensitive adhesive layer preferably contains the photostabilizer in combination with the ultraviolet absorber. The photostabilizer can trap radicals formed via photooxidation and allows the pressure-sensitive adhesive layer to have better resistance to light (in particular, to ultraviolet rays). Each of different photostabilizers may be used alone or in combination.

Examples of the photostabilizer include, but are not limited to, phenolic photostabilizers (phenolic compounds), phosphorus photostabilizers (phosphorus compounds), thioether photostabilizers (thioether compounds), and amine photostabilizers (amine compounds) (in particular, hindered amine stabilizers (hindered amine compounds)).

Examples of the phenolic photostabilizers (phenolic compounds) include, but are not limited to, 2,6-di-tert-butyl-4-methylphenol, 4-hydroxymethyl-2,6-di-tert-butylphenol, 2,6-di-tert-butyl-4-ethylphenol, butylated hydroxyanisole, n-octadecyl 3-(4-hydroxy-3,5-di-tert-butylphenyl)propionate, distearyl (4-hydroxy-3-methyl-5-tert-butyl)benzylmalonate, tocopherol, 2,2′-methylenebis(4-methyl-6-tert-butylphenol), 2,2′-methylenebis(4-ethyl-6-tert-butylphenol), 4,4′-methylenebis(2,6-di-tert-butylphenol), 4,4′-butylidenebis(6-tert-butyl-m-cresol), 4,4′-thiobis(6-tert-butyl-m-cresol), styrenated phenol, N,N′-hexamethylenebis(3,5-di-tert-butyl-4-hydroxyhydrocinnamide, calcium bis[monoethyl(3,5-di-tert-butyl-4-hydroxybenzyl)phosphonate], 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, tetrakis[3-(3,5-di-tert-butyl-4-hydroxyphenyl)propionyloxymethyl]methane, 1,6-hexanediol bis[3-(3,5-di-tert-butyl-4-hydroxyphenyl)propionate], 2,2′-methylenebis(4-methyl-6-cyclohexylphenol), 2,2′-methylenebis[6-(1-methylcyclohexyl)-p-cresol], 1,3,5-tris(4-tert-butyl-3-hydroxy-2,6-dimethylbenzyl) isocyanurate, 1,3,5-tris(3,5-di-tert-butyl-4-hydroxybenzyl) isocyanurate, triethylene glycol bis[3-(3-tert-butyl-4-hydroxy-5-methylphenyl) propionate], 2,2′-oxamidobis[ethyl 3-(3,5-di-tert-butyl-4-hydroxyphenyl)propionate], 6-(4-hydroxy-3,5-di-tert-butylanilino)-2,4-dioctylthio-1,3,5-triazine, bis[2-tert-butyl-4-methyl-6-(2-hydroxy-3-tert-butyl-5-methylbenzyl)phenyl] terephthalate, 3,9-bis(2-[3-(3-tert-butyl-4-hydroxy-5-methylphenyl)propionyloxy]-1,1-dimethylethyl)-2,4,8,10-tetraoxaspiro[5.5]undecane, and 3,9-bis(2-[3-(3,5-di-tert-butyl-4-hydroxyphenyl)propionyloxy]-1,1-dimethylethyl)-2,4,8,10-tetraoxaspiro[5.5]undecane.

Examples of the phosphorus photostabilizers (phosphorus compounds) include, but are not limited to, tris(nonylphenyl) phosphite, tris(2,4-di-tert-butylphenyl) phosphite, tris[2-tert-butyl-4-(3-tert-butyl-4-hydroxy-5-methylphenylthio)-5-methylphenyl] phosphite, tridecyl phosphite, octyl diphenyl phosphite, didecyl monophenyl phosphite, bis(tridecyl)pentaerythritol diphosphite, distearylpentaerythritol diphosphite, bis(nonylphenyl)pentaerythritol diphosphite, bis(2,4-di-tert-butylphenyl)pentaerythritol diphosphite, bis(2,6-di-tert-butyl-4-methylphenyl)pentaerythritol diphosphite, bis(2,4,6-tri-tert-butylphenyl)pentaerythritol diphosphite, tetra(tridecyl)isopropylidenediphenol diphosphite, tetra(tridecyl)-4,4′-n-butylidenebis(2-tert-butyl-5-methylphenol) diphosphite, hexa(tridecyl)-1,1,3-tris(2-methyl-4-hydroxy-5-tert-butylphenyl)butane triphosphite, tetrakis(2,4-di-tert-butylphenyl)biphenylene diphosphonite, 9,10-dihydro-9-oxa-10-phosphaphenanthrene-10-oxide, and tris(2-[(2,4,8,10-tetrakis-tert-butyldibenzo[d,f][1,3,2]dioxaphosphepin-6-yl)oxy]ethyl)amine.

Examples of the thioether photostabilizers (thioether compounds) include, but are not limited to, dialkyl thiodipropionate compounds such as dilauryl thiodipropionate, dimyristyl thiodipropionate, and distearyl thiodipropionate; and β-alkylmercaptopropionic acid esters of polyols, such as tetrakis[methylene-(3-dodecylthio)propionate]methane.

Examples of the amine photostabilizers (amine compounds) include, but are not limited to, a polymerized product of 4-hydroxy-2,2,6,6-tetramethyl-1-piperidineethanol with dimethyl succinate (e.g., trade name Tinuvin 622, supplied by BASF SE); a 1:1 reaction product of N,N′,N″,N′″-tetrakis-(4,6-bis-(butyl-(N-methyl-2,2,6,6-tetramethylpiperidin-4-yl)amino)-triazin-2-yl)-4,7-diazadecane-1,10-diamine and a polymerized product of 4-hydroxy-2,2,6,6-tetramethyl-1-piperidineethanol with dimethyl succinate (e.g., trade name Tinuvin 119, supplied by BASF SE); N,N′-bis(2,2,6,6-tetramethyl-4-piperidinyl)-1,6-hexanediamine polymer with 2,4,6-trichloro-1,3,5-triazine reaction products with N-butyl-1-butanamine and N-butyl-2,2,6,6-tetramethyl-4-piperidinamine (e.g., trade name Tinuvin 2020, supplied by BASF SE); poly[[6-[(1,1,3,3-tetramethylbutyl)amino]-1,3,5-triazine-2,4-diyl][(2,2,6,6-tetramethyl-4-piperidinyl)imino]hexamethylene[(2,2,6,6-tetramethyl-4-piperidinyl)imino]] (e.g., trade name Tinuvin 944, supplied by BASF SE); a mixture of bis(1,2,2,6,6-pentamethyl-4-piperidyl) sebacate and methyl 1,2,2,6,6-pentamethyl-4-piperidylsebacate (e.g., trade name Tinuvin 765, supplied by BASF SE); bis(2,2,6,6-tetramethyl-4-piperidyl) sebacate (e.g., trade name Tinuvin 770, supplied by BASF SE); decanedioic acid bis(2,2,6,6-tetramethyl-1-(octyloxy)-4-piperidinyl) ester, reaction products with 1,1-dimethylethyl hydroperoxide and octane (e.g., trade name Tinuvin 123, supplied by BASF SE); bis(1,2,2,6,6-pentamethyl-4-piperidyl)[[3,5-bis(1,1-dimethylethyl)-4-hydroxyphenyl]methyl]butylmalonate (e.g., trade name Tinuvin 144, supplied by BASF SE); peroxy-N-butyl-2,2,6,6-tetramethyl-4-piperidinamine-2,4,6-trichloro-1,3,5-triazine, reaction products with cyclohexane, reaction products with 2-aminoethanol (e.g., trade name Tinuvin 152, supplied by BASF SE); mixtures of bis(1,2,2,6,6-pentamethyl-4-piperidyl) sebacate and methyl 1,2,2,6,6-pentamethyl-4-piperidyl sebacate (e.g., trade name Tinuvin 292, supplied by BASF SE); reaction products (esterified products) of 1,2,3,4-butanetetracarboxylic acid and 1,2,2, 6,6-pentamethyl-4-piperidinol with 3,9-bis(2-hydroxy-1,1-dimethylethyl)-2,4,8,10-tetraoxaspiro[5.5]undecane (e.g., trade name ADK STAB LA-63P, supplied by ADEKA CORPORATION). Of the amine stabilizers, hindered amine stabilizers are particularly preferred.

Assume that the pressure-sensitive adhesive layer for use in the present invention contains the photostabilizer. In this case, the pressure-sensitive adhesive layer for use in the present invention (in particular, the acrylic pressure-sensitive adhesive layer) may contain the photostabilizer in a proportion not limited, but preferably equal to or more than 0.1 part by weight, and more preferably equal to or more than 0.2 part by weight, per 100 parts by weight of the base polymer. This is preferred for the pressure-sensitive adhesive sheet to more readily develop resistance to light. The proportion in terms of upper limit is not limited, but is preferably equal to or less than 5 parts by weight, and more preferably equal to or less than 3 parts by weight, per 100 parts by weight of the base polymer. This is preferred for the photostabilizer itself to less cause coloring and to thereby readily offer high transparency, and for the pressure-sensitive adhesive layer to have satisfactory optical properties.

The pressure-sensitive adhesive layer for use in the present invention may be formed typically, but not limitatively, using a crosslinking agent. Upon use, the crosslinking agent can crosslink, for example, the acrylic polymer in the acrylic pressure-sensitive adhesive layer and can control the gel fraction. Each of different crosslinking agents may be used alone or in combination.

Examples of the crosslinking agents include, but are not limited to, isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Among them, isocyanate crosslinking agents and epoxy crosslinking agents are preferred, of which isocyanate crosslinking agents are more preferred.

Examples of the isocyanate crosslinking agents (multifunctional isocyanate compounds) include, but are not limited to, lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanates, cyclohexylene diisocyanates, isophorone diisocyanate, hydrogenated tolylene diisocyanates, and hydrogenated xylene diisocyanates; and aromatic polyisocyanates such as 2,4-tolylene diisocyanate, 2,6-tolylene diisocyanate, 4,4′-diphenylmethane diisocyanate, and xylylene diisocyanates. Examples of the isocyanate crosslinking agents also include, but are not limited to, commercial products such as trimethylolpropane/tolylene diisocyanate adduct (e.g., trade name CORONATE L, supplied by Tosoh Corporation), trimethylolpropane/hexamethylene diisocyanate adduct (e.g., trade name CORONATE HL, supplied by Tosoh Corporation), and trimethylolpropane/xylylene diisocyanate adduct (e.g., trade name TAKENATE D-110N, supplied by Mitsui Chemicals Inc.).

Examples of the epoxy crosslinking agents (multifunctional epoxides) include, but are not limited to, N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, poly(ethylene glycol) diglycidyl ethers, poly(propylene glycol) diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, diglycidyl o-phthalate, triglycidyl-tris(2-hydroxyethyl) isocyanurate, resorcinol diglycidyl ether, bisphenol-S diglycidyl ether; as well as epoxy resins containing two or more epoxy groups in the molecule. Examples of the epoxy crosslinking agents also include, but are not limited to, commercial products such as trade name TETRAD C (supplied by MITSUBISHI GAS CHEMICAL COMPANY, INC.).

Assume that the pressure-sensitive adhesive layer for use in the present invention is formed using the crosslinking agent. In this case, the crosslinking agent may be used in an amount not limited, but preferably equal to or more than 0.001 part by weight, and more preferably equal to or more than 0.01 part by weight, per 100 parts by weight of the base polymer. This is preferred for sufficient bonding reliability. The amount of the crosslinking agent in terms of upper limit is preferably equal to or less than 10 parts by weight, and more preferably equal to or less than 5 parts by weight, per 100 parts by weight of the base polymer. This is preferred for the pressure-sensitive adhesive layer to have appropriate flexibility and to have a higher adhesive strength.

The pressure-sensitive adhesive layer for use in the present invention (in particular, the acrylic pressure-sensitive adhesive layer) may contain a silane coupling agent for better bonding reliability, in particular better bonding reliability with respect to glass, under high-humidity conditions. The pressure-sensitive adhesive layer may contain each of different silane coupling agents alone or in combination. The pressure-sensitive adhesive layer, when containing the silane coupling agent, may have better adhesiveness, in particular adhesiveness to glass, under high-humidity conditions.

Examples of the silane coupling agent include, but are not limited to, γ-glycidoxypropyltrimethoxysilane, γ-glycidoxypropyltriethoxysilane, γ-aminopropyltrimethoxysilane, and N-phenyl-aminopropyltrimethoxysilane. Examples of the silane coupling agent also include, but are not limited to, commercial products such as KBM-403 (trade name, supplied by Shin-Etsu Chemical Co., Ltd.). Of the silane coupling agents, γ-glycidoxypropyltrimethoxysilane is preferred.

Assume that the pressure-sensitive adhesive layer for use in the present invention contains the silane coupling agent. In this case, the pressure-sensitive adhesive layer for use in the present invention (in particular, the acrylic pressure-sensitive adhesive layer) may contain the silane coupling agent in a proportion not limited, but preferably equal to or more than 0.01 part by weight, and more preferably equal to or more than 0.02 part by weight, per 100 parts by weight of the base polymer. The proportion of the silane coupling agent in terms of upper limit is preferably equal to or less than 1 part by weight, and more preferably equal to or less than 0.5 part by weight, per 100 parts by weight of the base polymer.

The pressure-sensitive adhesive layer for use in the present invention may further contain one or more additives as needed within ranges not adversely affecting the advantageous effects of the present invention. Examples of the additives include, but are not limited to, cross-linking promoters, tackifier resins (e.g., rosin derivatives, polyterpene resins, petroleum resins, and oil-soluble phenols), age inhibitors, fillers, colorants (e.g., pigments and dyestuffs), antioxidants, chain-transfer agents, plasticizers, softeners, surfactants, and antistatic agents. The pressure-sensitive adhesive layer may contain each of different additives alone or in combination.

Assume that the pressure-sensitive adhesive layer for use in the present invention is formed from (derived from) a solvent-borne acrylic pressure-sensitive adhesive composition, namely, the pressure-sensitive adhesive layer for use in the present invention is a solvent-based acrylic pressure-sensitive adhesive layer. In this case, the pressure-sensitive adhesive layer for use in the present invention preferably contains, among the components, the acrylic polymer and the ultraviolet absorber. More preferably, the pressure-sensitive adhesive layer contains the acrylic polymer in a content of equal to or more than 50 percent by weight based on the total weight (100 percent by weight) of the pressure-sensitive adhesive layer; and the ultraviolet absorber in a proportion of 0.05 to 9 parts by weight (furthermore preferably 0.1 to 8 parts by weight) per 100 parts by weight of the acrylic polymer. This is preferred from the viewpoint of having an extracted acrylic acid ion amount of equal to or less than 5 μg per gram of the pressure-sensitive adhesive layer. The pressure-sensitive adhesive layer for use in the present invention particularly preferably contains a specific acrylic polymer in a content of equal to or more than 50 percent by weight based on the total weight (100 percent by weight) of the pressure-sensitive adhesive layer; and an ultraviolet absorber in a proportion of 0.05 to 9 parts by weight (preferably 0.1 to 8 parts by weight) per 100 parts by weight of the acrylic polymer. The acrylic polymer just mentioned above is derived from a monomer mixture including 50 to 90 percent by weight (preferably 55 to 85 percent by weight) of a (meth)acrylic alkyl ester containing a C₄-C₁₈ straight- or branched-chain alkyl group; 10 to 50 percent by weight (preferably 15 to 40 percent by weight) of at least one monomer selected from the group consisting of nitrogen-containing monomers and hydroxy-containing monomers; and 0 to 40 percent by weight (preferably 0 to 30 percent by weight) of a monomer having a C₆-C₁₀ alicyclic structure.

Assume that the pressure-sensitive adhesive layer for use in the present invention is formed from (derived from) an active-energy-ray-curable acrylic pressure-sensitive adhesive composition, namely, the pressure-sensitive adhesive layer for use in the present invention is an active-energy-ray-cured acrylic pressure-sensitive adhesive layer. From the viewpoint of having an extracted acrylic acid ion amount of equal to or less than 5 μg per gram of the pressure-sensitive adhesive layer, the pressure-sensitive adhesive layer for use in the present invention in this case preferably has any of configurations as follows. The pressure-sensitive adhesive layer preferably contains, of the components, an acrylic polymer derived from a specific monomer mixture. This monomer mixture includes 50 to 90 percent by weight (preferably 55 to 85 percent by weight) of a (meth)acrylic alkyl ester containing a C₄-C₁₈ straight- or branched-chain alkyl group; and 10 to 50 percent by weight (preferably 15 to 40 percent by weight) of at least one monomer selected from the group consisting of nitrogen-containing monomers and hydroxy-containing monomers. The pressure-sensitive adhesive layer more preferably contains equal to or more than 50 percent by weight of an acrylic polymer derived from the above-mentioned specific monomer mixture. In particular, the pressure-sensitive adhesive layer for use in the present invention still more preferably contains equal to or more than 50 percent by weight of an acrylic polymer derived from a monomer mixture. This monomer mixture contains 50 to 90 percent by weight (preferably 55 to 85 percent by weight) of a (meth)acrylic alkyl ester containing a C₄-C₁₈ straight- or branched-chain alkyl group; 3 to 30 percent by weight (preferably 5 to 25 percent by weight) of a nitrogen-containing monomer; 0.8 to 25 percent by weight (preferably 1 to 15 percent by weight) of a hydroxy-containing monomer; and 0 to 40 percent by weight (preferably 0 to 30 percent by weight) of a monomer having a C₆-C₁₀ alicyclic structure, in which the total of proportions of the nitrogen-containing monomer and the hydroxy-containing monomer is 10 to 50 percent by weight (preferably 15 to 40 percent by weight).

The pressure-sensitive adhesive layer for use in the present invention may have a haze not limited, but preferably equal to or less than 5%, more preferably equal to or less than 3%, and furthermore preferably equal to or less than 1%. This is preferred in points of appearance properties, transparency, and optical properties. The haze herein may be measured typically with a haze meter in conformity to Japanese Industrial Standard (JIS) K 7136.

The pressure-sensitive adhesive layer for use in the present invention may have a total luminous transmittance not limited, but preferably equal to or more than 85%, more preferably equal to or more than 90%, and furthermore preferably equal to or more than 92%. This is preferred in points of appearance properties, transparency, and optical properties. The total luminous transmittance herein may be measured typically with a haze meter in conformity to JIS K 7361-1. The term “total luminous transmittance” as used herein refers to a transmittance with respect to light (visible light) at wavelengths of 400 to 780 nm.

The pressure-sensitive adhesive layer for use in the present invention may have a color space coordinate a* not limited, but preferably equal to or more than −0.5, more preferably equal to or more than −0.3, and furthermore preferably equal to or more than −0.1. This is preferred for offering excellent optical properties and excellent appearance properties. The pressure-sensitive adhesive layer preferably has an a* of equal to or less than 0.5, more preferably equal to or less than 0.3, and furthermore preferably equal to or less than 0.1. This is preferred for offering excellent optical properties and excellent appearance properties. The term “a*” herein refers to an a* coordinate in the L*a*b* color space (the CIE 1976 L*a*b* color space) and may be measured typically with a handy spectrophotometric color difference meter (trade name DOT-3C, supplied by Murakami Color Research Laboratory) in conformity to JIS Z 8781-4:2013.

The pressure-sensitive adhesive layer for use in the present invention may have a color space coordinate b* not limited, but preferably equal to or less than 0.7, more preferably equal to or less than 0.5, and furthermore preferably equal to or less than 0.4. The pressure-sensitive adhesive layer, when having a b* of equal to or less than 0.7, may have excellent optical properties and excellent appearance properties. Advantageously, the resulting optical pressure-sensitive adhesive sheet according to the embodiment of the present invention, when used in an optical product (in particular, an optical product including a display panel such as a liquid crystal display (LCD)), does not approximately adversely affect the screen brightness, color density, and hue of the optical product. The term “b*” herein refers to a b* coordinate in the L*a*b* color space and may be measured typically with a handy spectrophotometric color difference meter (trade name DOT-3C, supplied by Murakami Color Research Laboratory) in conformity to JIS Z 8781-4:2013.

The pressure-sensitive adhesive layer for use in the present invention may have a thickness not limited, but preferably equal to or more than 12 μm, more preferably equal to or more than 15 μm, furthermore preferably equal to or more than 20 μm, and particularly preferably equal to or more than 70 μm. This is preferred for maintaining satisfactory ultraviolet absorptivity and still offering sufficient bonding reliability with respect to the silver nanowire layer and/or the protective layer. Advantageously, the pressure-sensitive adhesive layer, when having a thickness of equal to or more than 12 μm, may have a further reduced extracted acrylic acid ion amount. From the viewpoint of optical properties, the pressure-sensitive adhesive layers may have a thickness of equal to or less than 500 μm, more preferably equal to or less than 300 μm, and furthermore preferably equal to or less than 200 μm.

The pressure-sensitive adhesive layer for use in the present invention (in particular, the acrylic pressure-sensitive adhesive layer) may be prepared typically, but not limitatively, by applying the pressure-sensitive adhesive composition onto a carrier or release liner to give a pressure-sensitive adhesive composition layer, and drying and curing the pressure-sensitive adhesive composition layer; or by applying the pressure-sensitive adhesive composition onto a carrier or release liner to give a pressure-sensitive adhesive composition layer, applying an active energy ray to the pressure-sensitive adhesive composition layer, and thereby curing the layer. The resulting layer may be further heated and dried as needed.

Examples of the active energy ray include, but are not limited to, ionizing radiation such as alpha rays, beta rays, gamma rays, neutron beams, and electron beams; and ultraviolet rays. Among them, ultraviolet rays are preferred. The irradiation with (application of) the active energy ray is not limited in conditions such as irradiation energy, irradiation time, and irradiation method.

The pressure-sensitive adhesive composition may be prepared by a known or common method. For example, the solvent-borne acrylic pressure-sensitive adhesive composition may be prepared typically by adding one or more additives (e.g., ultraviolet absorber) as needed to a solution containing the acrylic polymer. The active-energy-ray-curable acrylic pressure-sensitive adhesive composition may be prepared typically by adding one or more additives (e.g., ultraviolet absorber) as needed to a mixture containing the acrylic monomer(s), or to a partially polymerized product of the mixture.

The application of (coating with) the pressure-sensitive adhesive composition may be performed using a known coating technique. For example, the coating may be performed using any of coaters such as rotogravure roll coaters, reverse roll coaters, kiss-contact roll coaters, dip roll coaters, bar coaters, knife coaters, spray coaters, comma coaters, and direct coaters.

Assume that the pressure-sensitive adhesive layer is formed from an active-energy-ray-curable pressure-sensitive adhesive composition. In particular in this case, the active-energy-ray-curable pressure-sensitive adhesive composition preferably contains a photoinitiator. Assume that the active-energy-ray-curable pressure-sensitive adhesive composition contains an ultraviolet absorber. In this case, the photoinitiator to be contained is preferably a photoinitiator that has light absorptive properties in a wide wavelength range. For example, the composition preferably contains a photoinitiator that has light absorptive properties with respect to not only ultraviolet rays, but also visible light. This is because, although the ultraviolet absorber might adversely affect the curing by the active energy ray, the pressure-sensitive adhesive composition, when containing such a photoinitiator having light absorptive properties in a wide wavelength range, may readily offer high photocurability.

Carrier

Assume that the optical pressure-sensitive adhesive sheet according to the embodiment of the present invention is a carrier-supported pressure-sensitive adhesive sheet. In this case, examples of the carrier (substrate) include, but are not limited to, plastic films, antireflection (AR) films, polarizing plates, retardation films, and any other optical films. Non-limiting examples of materials for the plastic films and other films include plastic materials including polyester resins such as poly(ethylene terephthalate)s (PETs); acrylic resins such as poly(methyl methacrylate)s (PMMAs); polycarbonates; triacetyl celluloses (cellulose acetates) (TACs); polysulfones; polyarylates; polyimides; poly(vinyl chloride)s; poly(vinyl acetate)s; polyethylenes; polypropylenes; ethylene-propylene copolymers; and cycloolefinic polymers such as products under the trade name ARTON (cycloolefinic polymer, supplied by JSR Corporation) and the trade name ZEONOR (cycloolefinic polymer, supplied by ZEON CORPORATION). Each of different plastic materials may be used alone or in combination. The term “carrier” as used herein refers to a portion that is applied (affixed) together with the pressure-sensitive adhesive layer to an adherend such as an optical element upon the application (affixation) of the pressure-sensitive adhesive sheet. The “carrier” excludes release liners which are removed on or before the use (application) of the pressure-sensitive adhesive sheet.

The carrier is preferably transparent. The carrier may have a total luminous transmittance in the visible light wavelength region of not limited, but preferably equal to or more than 85%, and more preferably equal to or more than 88%, where the total luminous transmittance is determined in conformity to JIS K 7361-1. The carrier may have a haze not limited, but preferably equal to or less than 1.5%, and more preferably equal to or less than 1.0%, where the haze is determined in conformity to JIS K 7136.

The carrier may have a thickness not limited, but typically preferably 12 to 75 μm. The carrier may have either a single-layer structure or a multilayer structure. The carrier may undergo a known or common surface treatment on its surface as appropriate. Examples of the surface treatment include, but are not limited to, physical treatments such as corona discharge treatment and plasma treatment; and chemical treatments such as primer coating.

Release Liner

The optical pressure-sensitive adhesive sheet according to the embodiment of the present invention may be provided with a release liner (separator) on the surface (adhesive face) of the pressure-sensitive adhesive layer. Assume that the optical pressure-sensitive adhesive sheet according to the embodiment of the present invention is a double-sided pressure-sensitive adhesive sheet. In this case, the two adhesive faces may be protected respectively by two release liners, or may be protected by one release liner having two release surfaces as both surfaces thereof, where the sheet with the release liner is wound and present as a roll. The release liner or liners are used as protectors for the pressure-sensitive adhesive layer and are removed on or before the application of the sheet to an adherend. Assume that the optical pressure-sensitive adhesive sheet according to the embodiment of the present invention is a pressure-sensitive adhesive transfer sheet. In this case, the release liner functions also as a support for the pressure-sensitive adhesive layer. The release liner does not necessarily have to be provided.

The release liner is exemplified by, but not limited to, common release papers, such as substrates having a release coating layer (release treatment layer); low-adhesiveness substrates including a fluorocarbon polymer; and low-adhesiveness substrates including a nonpolar polymer. Examples of the substrates having a release coating layer include, but are not limited to, plastic films and papers, each of which has been surface-treated with a release agent. Examples of the release agent include, but are not limited to, silicone-, long-chain alkyl-, fluorocarbon-, and molybdenum sulfide-release agents. In the low-adhesiveness substrates including a fluorocarbon polymer, examples of the fluorocarbon polymer include, but are not limited to, polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-vinylidene fluoride copolymers.

Examples of the nonpolar polymer include, but are not limited to, olefinic resins such as polyethylenes and polypropylenes. The release liner may be formed by a known or common technique. The release liner may have a thickness not limited.

Optical Pressure-Sensitive Adhesive Sheet According to Embodiment of Present Invention

The optical pressure-sensitive adhesive sheet according to the embodiment of the present invention may have a thickness not limited, but preferably equal to or more than 12 μm, more preferably equal to or more than 15 μm, furthermore preferably equal to or more than 20 μm, and particularly preferably equal to or more than 50 μm. In point of optical properties, the optical pressure-sensitive adhesive sheet has a thickness of preferably equal to or less than 500 μm, more preferably equal to or less than 300 μm, and furthermore preferably equal to or less than 200 μm. The thickness of the optical pressure-sensitive adhesive sheet according to the embodiment of the present invention excludes the thickness of the release liner(s).

The optical pressure-sensitive adhesive sheet according to the embodiment of the present invention may have a rate of resistance increase of not limited, but preferably equal to or less than 3 times (e.g., 0 to 3 times), more preferably equal to or less than 2 times (e.g., 0 to 2 times), and furthermore preferably equal to or less than 1.5 times (e.g., 0 to 1.5 times). The term “rate of resistance increase” refers to the ratio (in times) of a resistance after 100-hour UV irradiation to a resistance immediately after affixation, where the “resistance immediately after affixation” refers to a resistance that is measured immediately after the optical pressure-sensitive adhesive sheet is applied to (affixed to) an optical element including a silver nanowire layer; and the “resistance after 100-hour UV irradiation” refers to a resistance that is measured after the optical pressure-sensitive adhesive sheet is applied to the optical element including the silver nanowire layer and is then irradiated with an ultraviolet ray for 100 hours.

The “resistance after 100-hour UV irradiation” may be determined typically by affixing the optical pressure-sensitive adhesive sheet to an optical element including a silver nanowire layer to give a sample, irradiating the sample with an ultraviolet ray at an ambient temperature of 45° C. and relative humidity of 50% at an illuminance of 65 W/cm² for 100 hours, and measuring the resistance of the resulting sample. The “resistance immediately after affixation” and the “resistance after 100-hour UV irradiation” may be measured using a known or common resistance measurement instrument such as a product under the trade name EC-80 (supplied by NAPSON CORPORATION). The ultraviolet irradiation may be performed using a known or common ultraviolet irradiator such as a product under the trade name Super Xenon Weather Meter SX75 (supplied by Suga Test Instruments Co., Ltd.). The optical pressure-sensitive adhesive sheet, when to be affixed to an optical element including a silver nanowire layer for resistance measurement, is preferably applied to (affixed to) the silver nanowire layer which may have the protective layer.

The optical pressure-sensitive adhesive sheet according to the embodiment of the present invention may have a haze not limited, but preferably equal to or less than 5%, more preferably equal to or less than 3%, and furthermore preferably equal to or less than 1%. This is preferred in points of appearance properties, transparency, and optical properties.

The optical pressure-sensitive adhesive sheet according to the embodiment of the present invention may have a total luminous transmittance not limited, but preferably equal to or more than 85%, more preferably equal to or more than 90%, and furthermore preferably equal to or more than 92%. This is preferred in points of appearance properties, transparency, and optical properties.

The optical pressure-sensitive adhesive sheet according to the embodiment of the present invention may have a color coordinate a* not limited, but preferably equal to or more than −0.5, more preferably equal to or more than −0.3, and furthermore preferably equal to or more than −0.1. This is preferred in point of offering excellent optical properties and excellent appearance properties. The optical pressure-sensitive adhesive sheet has an a* of preferably equal to or less than 0.5, more preferably equal to or less than 0.3, and furthermore preferably equal to or less than 0.1, for offering excellent optical properties and excellent appearance properties.

The optical pressure-sensitive adhesive sheet according to the embodiment of the present invention may have a color coordinate b* not limited, but preferably equal to or less than 0.7, more preferably equal to or less than 0.5, and furthermore preferably equal to or less than 0.4. This is preferred in points of offering excellent optical properties and excellent appearance properties.

The optical pressure-sensitive adhesive sheet according to the embodiment of the present invention may have an adhesive strength in the pressure-sensitive adhesive layer for use in the present invention of not limited, but preferably equal to or more than 6 N/20 mm, more preferably equal to or more than 7 N/20 mm, and furthermore preferably equal to or more than 10 N/20 mm. This is preferred in point of bonding reliability with respect to the silver nanowire layer and/or the protective layer. The adhesive strength herein is a 180-degree peel adhesion and may be measured in conformity to JIS Z 0237 by peeling off the optical pressure-sensitive adhesive sheet from the adherend at a tensile speed of 300 mm/min and a peel angle of 180 degrees.

For better non-corrosivity with respect to thin metal films to which optical pressure-sensitive adhesive sheets are applied, conventional optical pressure-sensitive adhesive sheets are designed to use a smaller amount of (meth)acrylic acid in monomer components to constitute an acrylic polymer in the pressure-sensitive adhesive layer. With this configuration, the amount of acrylic acid ions and methacrylic acid ions extracted from the pressure-sensitive adhesive sheets is controlled to be equal to or less than 20 ng per unit area (square centimeter) of the pressure-sensitive adhesive layer. The conventional optical pressure-sensitive adhesive sheets, when using no (meth)acrylic acid in monomer components to form the polymer in the pressure-sensitive adhesive layer, can have an amount of extracted acrylic acid ions and methacrylic acid ions of equal to or less than 20 ng per square centimeter. However, the conventional optical pressure-sensitive adhesive sheets having this configuration may have insufficient non-corrosivity with respect to silver nanowire layers, although the pressure-sensitive adhesive sheets have sufficient non-corrosivity with respect to ITO layers. Specifically, even when no (meth)acrylic acid is used in monomer components to form the polymer in the pressure-sensitive adhesive layer, the conventional pressure-sensitive adhesive sheets may have insufficient non-corrosivity with respect to silver nanowire layers. In contrast, the optical pressure-sensitive adhesive sheet according to the embodiment of the present invention is an optical pressure-sensitive adhesive sheet for silver nanowire layer use. The optical pressure-sensitive adhesive sheet includes such a pressure-sensitive adhesive layer as to have an amount of extracted acrylic acid ions of equal to or less than 5 μg per gram of the pressure-sensitive adhesive layer, where the acrylic acid ions are extracted from the pressure-sensitive adhesive layer with pure water via extraction at 100° C. for 45 minutes, and the amount of which is measured by ion chromatography. This configuration restrains the ionization of silver in a silver nanowire layer by acrylic acid ions, allows the optical pressure-sensitive adhesive sheet to have better non-corrosivity (in particular, better UV-resistant non-corrosivity), and can restrain resistance increase (in particular, resistance increase upon ultraviolet irradiation). These advantages can be obtained even when the optical pressure-sensitive adhesive sheet according to the embodiment of the present invention is applied so that the pressure-sensitive adhesive layer faces an optical element where the silver nanowire layer is present, in particular, even when the pressure-sensitive adhesive layer is applied directly to the silver nanowire layer, or applied to a layer that protects the silver nanowire layer.

The optical pressure-sensitive adhesive sheet according to the embodiment of the present invention is preferably, but not limitatively, produced according to a known or common production method. For example, assume that the optical pressure-sensitive adhesive sheet according to the embodiment of the present invention is a pressure-sensitive adhesive transfer sheet. In this case, the optical pressure-sensitive adhesive sheet may be obtained by forming the pressure-sensitive adhesive layer for use in the present invention on a release liner by the above-mentioned method. Assume that the optical pressure-sensitive adhesive sheet according to the embodiment of the present invention is a carrier-supported pressure-sensitive adhesive sheet. In this case, the optical pressure-sensitive adhesive sheet may be obtained by a direct process or a transfer process. In the direct process, the pressure-sensitive adhesive layer for use in the present invention is formed directly on the carrier surface. In the transfer process, the pressure-sensitive adhesive layer for use in the present invention is formed once on a release liner and then transferred (affixed) onto the carrier to be disposed on the carrier.

The optical pressure-sensitive adhesive sheet according to the embodiment of the present invention is used in optical applications. More specifically, the optical pressure-sensitive adhesive sheet is used for a silver nanowire layer in optical applications, in which the optical pressure-sensitive adhesive sheet is applied to an optical element including the silver nanowire layer in a product (optical product) using (including) the optical element. The optical pressure-sensitive adhesive sheet according to the embodiment of the present invention may be applied to such optical element including the silver nanowire layer so that the adhesive face of the pressure-sensitive adhesive layer for use in the present invention is in contact with (is directly applied to) the silver nanowire layer, or may be applied to another layer than the silver nanowire layer. Examples of the other layer include, but are not limited to, protective layers; and after-mentioned optical elements other than the silver nanowire layer. Among these applications, the optical pressure-sensitive adhesive sheet according to the embodiment of the present invention is preferably used for silver nanowire layer affixation, in which the optical pressure-sensitive adhesive sheet is directly applied to the silver nanowire layer, or applied to a layer (protective layer) that protects the silver nanowire layer. Non-limiting examples of the silver nanowire layer include layers on which fine metal lines containing silver are printed in mesh; and silver nanowire films, which are films formed by metal nanowires (fine metal wires) containing silver.

The term “optical element” refers to an element or member that has one or more optical properties. Non-limiting examples of the optical properties include polarizability, photorefractivity, light scattering property, light reflectivity, optical transparency, optical absorptivity, optical diffractive ability, optical rotatory power, and visibility. Examples of a substrate (base plate) constituting the optical element include, but are not limited to, substrates constituting optical equipment such as display devices (image display devices) and input devices; and substrates for use in the optical equipment. Non-limiting examples of such substrates include polarizing plates, wave plates, retardation films, compensation films, brightness enhancing films, light guide plates, reflective films, antireflection films, hard coat films (films each including a plastic film (e.g., a poly(ethylene terephthalate) (PET) film) undergone a hard coat treatment on at least one side of the plastic film), transparent conductive films, films with graphical design function, decorative films, surface protective plates, prisms, lenses, color filters, transparent substrates (e.g., glass sensors, glass display panels (e.g., liquid crystal displays (LCDs)), glass plates with transparent electrodes, and other glass substrates); and multilayer substrates including any of these as stacked. These are also generically referred to as “functional films”. These films may include one or more layers selected typically from print layers and conductive polymer layers. As used herein the terms “plate” and “film” independently refer to and include forms such as plate, film, and sheet forms. For example, the term “polarizing films” also refers to and includes, but is not limited to, “polarizing plates” and “polarizing sheets”.

Examples of the optical element also include touch sensors and film sensors. More specifically, non-limiting examples of the optical element include transparent conductive films including: films having an indium tin oxide (ITO) layer at the surface; films having a zinc oxide (ZnO) layer at the surface; films using (including) metal nanoparticles, such as films obtained by coating the surface with a liquid containing metal nanoparticles, and films obtained by printing the surface with a liquid containing metal nanoparticles in mesh; films using (including) carbon nanotubes, such as films obtained by coating the surface with a dispersion containing carbon nanotubes, and films obtained by printing the surface with a liquid containing carbon nanotubes in mesh; films using (including) graphene, such as films having a graphene layer at the surface; and films using (including) conductive polymers, such as films having a conductive polymer layer at the surface, and films obtained by printing with a liquid containing a conductive polymer in mesh. In addition, non-limiting examples of the optical element include films using metals (in particular, copper), such as films having a mesh-like fine metal line pattern, and films having a metal layer; and silver nanowire films. Of the optical elements, the optical pressure-sensitive adhesive sheet according to the embodiment of the present invention is applied to ones including a silver nanowire layer.

Examples of the display devices include, but are not limited to, liquid crystal display devices, organic electroluminescence (EL) display devices, plasma display panels (PDPs), and electronic papers. Non-limiting examples of the input devices include touch screens (touch panels).

Exemplary substrates to constitute the optical element include, but are not limited to, substrates including (or made from) materials such as glass, acrylic resins, polycarbonates, poly(ethylene terephthalate) s, cycloolefin polymers, and thin metal films. Such substrates may be in a form selected typically from sheets, films, and plates. As used herein the term “optical element(s)” also refers to and includes members or elements that are used in display devices and input devices, play a role of adding graphical design function and/or a role of protecting, and still allow the display devices and input devices to maintain visibility, as described above. Examples of such members or elements include films with graphical design function, decorative films, and surface-protecting films.

The silver nanowire layer in the optical element may be protected by a protective layer. Specifically, the optical element may include a protective layer (layer that protects the silver nanowire layer) disposed on or over the silver nanowire layer.

The protective layer preferably contains one or more resins as essential components. Non-limiting examples of the resins include known or common resins including acrylic resins; polyester resins such as poly(ethylene terephthalate)s; aromatic resins such as polystyrenes, polyvinyltoluenes, and polyvinylxylenes; polyimides; polyamides; polyamideimides; polyurethane resins; epoxy resins; polyolefin resins; acrylonitrile-butadiene-styrene copolymers (ABSs); cellulosic resins; silicone resins; poly(vinyl chloride)s; polyacetates; polynorbornenes; synthetic rubbers; and fluorocarbon resins. The resins may be resins having conductivity (conductive resins), which are exemplified by, but are not limited to, conductive resins such as poly(3,4-ethylenedioxythiophene)s (PEDOTs), polyanilines, polythiophenes, and polydiacetylenes. Among them, an acrylic resin is preferred. The protective layer may contain the resin(s) (in particular, acrylic resin(s)) in a content not limited, but preferably equal to or more than 50 percent by weight (e.g., 50 to 100 percent by weight), more preferably equal to or more than 70 percent by weight, and furthermore preferably equal to or more than 95 percent by weight, based on the total weight (100 percent by weight) of the protective layer.

Examples of the acrylic resin include, but are not limited to, the acrylic polymers exemplified and described as the base polymer contained in the pressure-sensitive adhesive layer for use in the present invention. Among them, cure-type resins (preferably ultraviolet-cure-type resins) derived from one or more of the multifunctional monomers are preferred, of which cure-type resins (preferably ultraviolet-cure-type resins) derived from one or more multifunctional acrylates are more preferred. Examples of the multifunctional acrylates include, but are not limited to, pentaerythritol triacrylate (PETA), neopentyl glycol diacrylate (NPGDA), dipentaerythritol hexaacrylate (DPHA), dipentaerythritol pentaacrylate (DPPA), and trimethylolpropane triacrylate (TMPTA). Assume that the acrylic resin is derived from monomer components including one or more of the multifunctional monomers. In this case, the monomer components to constitute the acrylic resin contains the multifunctional monomers in a proportion not limited, but preferably equal to or more than 50 percent by weight (e.g., 50 to 100 percent by weight), more preferably equal to or more than 70 percent by weight, furthermore preferably equal to or more than 90 percent by weight, and particularly preferably equal to or more than 95 percent by weight, based on the total weight (100 percent by weight) of all the monomer components.

The monomer components may be polymerized using a photoinitiator (photopolymerization initiator). Examples of the photoinitiator include, but are not limited to, the above-mentioned photoinitiators. Upon use, the photoinitiator may be used in an amount not limited, but typically preferably equal to or more than 0.01 part by weight and more preferably equal to or more than 0.1 part by weight, preferably equal to or less than 10 parts by weight and more preferably equal to or less than 7 parts by weight, per 100 parts by weight of all the monomer components to constitute the acrylic resin.

The protective layer may be formed further using the above-mentioned crosslinking agent. The protective layer may further contain one or more additives as needed. Examples of the additives include, but are not limited to, stabilizers, corrosion inhibitors, age inhibitors, fillers, colorants (e.g., pigments and dyestuffs), antioxidants, plasticizers, softeners, surfactants, and antistatic agents.

The protective layer may be disposed so as to cover the entire surface of the silver nanowire layer (so as to bury the silver nanowire layer under the protective layer), or may be disposed so as to allow part of the silver nanowire layer to be exposed from or to protrude from the protective layer surface.

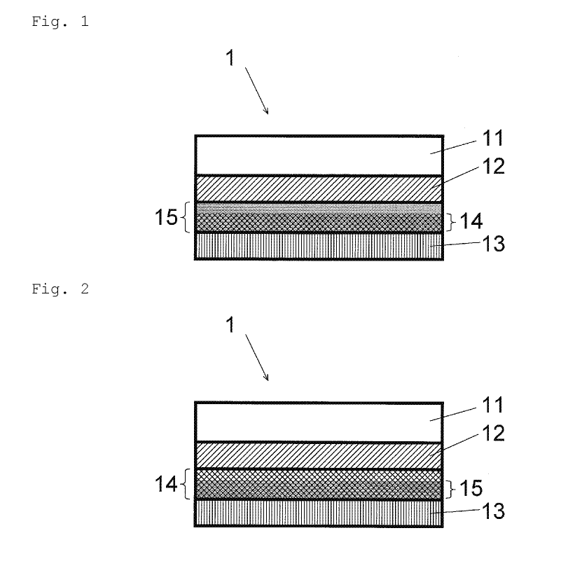

More specifically, optical pressure-sensitive adhesive sheets according embodiments of the present invention, which are used for a silver nanowire layer in optical applications, will be illustrated below. FIGS. 1 and 2 illustrate optical pressure-sensitive adhesive sheets according to the embodiments of the present invention, which are used for silver nanowire layer use (in particular, for silver nanowire layer affixation) in optical applications. The embodiments illustrated in FIGS. 1 and 2 correspond also to embodiments in which the optical pressure-sensitive adhesive sheets are used in film sensors. The optical pressure-sensitive adhesive sheets according to the embodiments of the present invention used for silver nanowire layer use in optical applications are not limited to the embodiments illustrated in FIGS. 1 and 2. FIGS. 1 and 2 are also schematic cross-sectional views of exemplary optical products in which the optical pressure-sensitive adhesive sheets according to the embodiments of the present invention are used. The optical products illustrated in FIGS. 1 and 2 each have a structure in which optical elements are bonded via the optical pressure-sensitive adhesive sheet according to the embodiment of the present invention. In FIGS. 1 and 2, an optical product 1 includes a cover 11, the optical pressure-sensitive adhesive sheet 12 according to the embodiment of the present invention, a substrate 13, a silver nanowire layer 14, and a protective layer 15. The cover 11 is cover glass or a cover lens. The substrate 13 is a substrate that supports the silver nanowire layer 14.

An optical element used in FIG. 1 includes the silver nanowire layer. The optical pressure-sensitive adhesive sheet 12 according to the embodiment of the present invention is disposed over one side of the silver nanowire layer 14 via the protective layer 15. The protective layer 15 is disposed so as to cover the entire surface of the silver nanowire layer 14 (so as to bury the silver nanowire layer 14 under the protective layer 15). Accordingly, the optical pressure-sensitive adhesive sheet according to the embodiment of the present invention is used for silver nanowire layer use (in particular, silver nanowire layer affixation use).

An optical element used in FIG. 2 includes the silver nanowire layer, as with the optical element in FIG. 1. In the optical product 1 illustrated in FIG. 2, the optical pressure-sensitive adhesive sheet 12 according to the embodiment of the present invention is disposed as directly applied to the silver nanowire layer 14. The protective layer 15 is disposed so as to allow at least part of the silver nanowire layer 14 to protrude from the protective layer 15. Accordingly, the optical pressure-sensitive adhesive sheet according to the embodiment of the present invention is used for silver nanowire layer use (in particular, silver nanowire layer affixation use).

In the optical products 1 illustrated in FIGS. 1 and 2, the optical pressure-sensitive adhesive sheets 12 according to the embodiments of the present invention are each applied to the optical element including the silver nanowire layer 14. The optical pressure-sensitive adhesive sheets 12 according to the embodiments of the present invention have excellent non-corrosivity with respect to the silver nanowire layer. This effectively restrains or minimizes the corrosion of silver nanowire layer by acrylic acid ions in the optical products 1. Since using the optical pressure-sensitive adhesive sheets 12 according to the embodiments of the present invention as above, the optical products 1 less suffer from corrosion of the silver nanowire layer and resist deterioration of themselves.

Optical Element with Optical Pressure-Sensitive Adhesive Sheet for Silver Nanowire Layer Use

An optical element with an optical pressure-sensitive adhesive sheet for silver nanowire layer use includes the optical element and the optical pressure-sensitive adhesive sheet according to the embodiment of the present invention.

Examples of the optical element with the optical pressure-sensitive adhesive sheet for silver nanowire layer use include, but are not limited to, optical pressure-sensitive adhesive sheet according to embodiments of the present invention, which are in the form of carrier-supported pressure-sensitive adhesive sheets in which an optical element including a silver nanowire layer constitutes the carrier. More specifically, the examples include pressure-sensitive adhesive sheets with optical elements, such as a pressure-sensitive adhesive sheet that includes a silver nanowire layer, and, on or over at least one side of the silver nanowire layer, at least one of the protective layer and the optical element in sheet form or film form, and the pressure-sensitive adhesive layer for use in the present invention disposed in this order; and a pressure-sensitive adhesive sheet that includes a silver nanowire layer and the pressure-sensitive adhesive layer for use in the present invention disposed directly on at least one side of the silver nanowire layer.

With the pressure-sensitive adhesive sheet with an optical element, the optical element including the silver nanowire layer can be secured or temporarily tacked at a desired position via the adhesive face of the optical pressure-sensitive adhesive sheet according to the embodiment of the present invention. The optical pressure-sensitive adhesive sheet according to the embodiment of the present invention effectively less causes corrosion of the silver nanowire layer. This allows the pressure-sensitive adhesive sheet with optical element to resist deterioration caused by corrosion of the silver nanowire layer.

Optical Product

An optical product includes an optical element including a silver nanowire layer; and an optical pressure-sensitive adhesive sheet according to an embodiment of the present invention. Examples of the optical product include, but are not limited to, the optical products (optical products 1) illustrated in FIGS. 1 and 2. The optical product includes the optical pressure-sensitive adhesive sheet according to the embodiment of the present invention which has excellent non-corrosivity (in particular, UV-resistant non-corrosivity) with respect to the silver nanowire layer. This configuration allows the optical product to resist deterioration caused by silver nanowire layer corrosion (in particular, silver nanowire corrosion as a result of ultraviolet irradiation).

### EXAMPLES

The present invention will be illustrated in further detail with reference to several examples below. It should be noted, however, that the examples are by no means intended to limit the scope of the present invention. All parts (parts by weight) in formulations are parts of components as indicated.

### Acrylic Polymer Preparation Example 1

In a four-necked flask, 60 parts by weight of dicyclopentanyl methacrylate (DCPMA), 40 parts by weight of methyl methacrylate (MMA), 3.5 parts by weight of α-thioglycerol as a chain-transfer agent, and 100 parts by weight of toluene as a polymerization solvent were placed, followed by stirring in a nitrogen atmosphere at 70° C. for one hour. Next, 0.2 part by weight of 2,2′-azobisisobutyronitrile as a polymerization initiator was placed into the four-necked flask, followed by performing a reaction at 70° C. for 2 hours and subsequently at 80° C. for 2 hours. The reaction mixture was then placed in an atmosphere at a temperature of 130° C. to dry and remove toluene, the chain-transfer agent, and unreacted monomers and yielded a solid acrylic polymer. This acrylic polymer is also referred to as “acrylic polymer (A)”. The acrylic polymer (A) had a weight-average molecular weight of 5100.

### Example 1

A monomer mixture containing 67 parts by weight of 2-ethylhexyl acrylate (2EHA), 15 parts by weight of N-vinyl-2-pyrrolidone (NVP), and 18 parts by weight of 2-hydroxyethyl acrylate (HEA) was prepared. The monomer mixture was combined with 0.035 part by weight of a photoinitiator (trade name IRGACURE 651, supplied by BASF SE) and 0.035 part by weight of another photoinitiator (trade name IRGACURE 184, supplied by BASF SE), followed by ultraviolet irradiation to a viscosity of about 20 Pa·s. This gave a prepolymer composition in which part of the monomer components was polymerized. The viscosity was measured using a BH viscometer with a No. 5 rotor, at 10 rpm and at a measurement temperature of 30° C.

The prepolymer composition was mixed with 5 parts by weight of the acrylic polymer (A), 0.075 part by weight of hexanediol diacrylate (HDDA), and 0.3 part by weight of a silane coupling agent (trade name KBM-403, supplied by Shin-Etsu Chemical Co., Ltd.) and yielded an acrylic pressure-sensitive adhesive composition.

The acrylic pressure-sensitive adhesive composition was applied onto a poly(ethylene terephthalate) (PET) release liner (supplied by Nitto Denko Corporation, 125 μm in thickness) to form a pressure-sensitive adhesive composition layer. Next, the pressure-sensitive adhesive composition layer was covered with another PET release liner (supplied by Nitto Denko Corporation, 125 μm in thickness) to exclude oxygen. This gave a laminate (laminate (I)) having a configuration including the release liner, the pressure-sensitive adhesive composition layer, and the release liner disposed in this order.

Next, an ultraviolet ray was applied to the laminate (I) from the top (release liner side) of the laminate (I) at an illuminance of 3 mW/cm² for 300 seconds using a black light lamp (supplied by TOSHIBA CORPORATION). The irradiated laminate was further subjected to a drying treatment using a dryer at 90° C. for 2 minutes to volatilize residual monomers, and yielded a double-sided pressure-sensitive adhesive sheet (pressure-sensitive adhesive transfer sheet). The resulting article had a configuration including a release liner, a pressure-sensitive adhesive layer, and a release liner disposed in this order, in which both adhesive faces of the pressure-sensitive adhesive layer were protected by the release liners. The double-sided pressure-sensitive adhesive sheet had a thickness (excluding the release liners) of 50 μm.

### Example 2

A double-sided pressure-sensitive adhesive sheet (pressure-sensitive adhesive transfer sheet) was prepared by a procedure similar to Example 1, except for forming a pressure-sensitive adhesive layer so as to have a thickness of 100 μm. The double-sided pressure-sensitive adhesive sheet had a thickness (excluding the release liners) of 100 μm.

### Example 3

A monomer mixture containing 40.5 parts by weight of 2-ethylhexyl acrylate (2EHA), 40.5 parts by weight of isostearyl acrylate (ISTA), 18 parts by weight of N-vinyl-2-pyrrolidone (NVP), and 1 part by weight of 4-hydroxybutyl acrylate (4HBA) was prepared. The monomer mixture was combined with 0.05 part by weight of a photoinitiator (trade name IRGACURE 651, supplied by BASF SE) and 0.5 part by weight of another photoinitiator (trade name IRGACURE 184, supplied by BASF SE), followed by ultraviolet irradiation to a viscosity of about 20 Pa·s. This gave a prepolymer composition in which part of the monomer components was polymerized. The viscosity was measured using a BH viscometer with a No. 5 rotor at 10 rpm and at a measurement temperature of 30° C.

The prepolymer composition was mixed with 0.02 part by weight of trimethylolpropane triacrylate (TMPTA) and 0.3 part by weight of a silane coupling agent (trade name KBM-403, supplied by Shin-Etsu Chemical Co., Ltd.) and yielded an acrylic pressure-sensitive adhesive composition.

Except for using the acrylic pressure-sensitive adhesive composition, a double-sided pressure-sensitive adhesive sheet (pressure-sensitive adhesive transfer sheet) was prepared by a procedure similar to Example 1. The resulting article had a configuration including a release liner, a pressure-sensitive adhesive layer, and a release liner disposed in this order, in which both adhesive faces of the pressure-sensitive adhesive layer were protected by the release liners. The double-sided pressure-sensitive adhesive sheet had a thickness (excluding the release liners) of 50 μm.

### Example 4

A double-sided pressure-sensitive adhesive sheet (pressure-sensitive adhesive transfer sheet) was prepared by a procedure similar to Example 3, except for forming a pressure-sensitive adhesive layer so as to have a thickness of 100 μm. The double-sided pressure-sensitive adhesive sheet had a thickness (excluding the release liners) of 100 μm.

### Example 5

A monomer mixture including 40.5 parts by weight of 2-ethylhexyl acrylate (2EHA), 40.5 part by weight of isostearyl acrylate (ISTA), 18 parts by weight of N-vinyl-2-pyrrolidone (NVP), and 1 part by weight of 4-hydroxybutyl acrylate (4HBA) was prepared. The monomer mixture was combined with 0.05 part by weight of a photoinitiator (trade name IRGACURE 651, supplied by BASF SE) and 0.5 part by weight of another photoinitiator (trade name IRGACURE 184, supplied by BASF SE), followed by ultraviolet irradiation to a viscosity of about 20 Pa·s. This gave a prepolymer composition in which part of the monomer components was polymerized. The viscosity was measured using a BH viscometer with a No. 5 rotor at 10 rpm and at a measurement temperature of 30° C.

The prepolymer composition was mixed with 0.15 part by weight of trimethylolpropane triacrylate (TMPTA), 0.3 part by weight of a silane coupling agent (trade name KBM-403, supplied by Shin-Etsu Chemical Co., Ltd.), and 0.15 part by weight of α-thioglycerol as a chain-transfer agent and yielded an acrylic pressure-sensitive adhesive composition.

Except for using the acrylic pressure-sensitive adhesive composition, a double-sided pressure-sensitive adhesive sheet (pressure-sensitive adhesive transfer sheet) was prepared by a procedure similar to Example 1. The resulting article had a configuration including a release liner, a pressure-sensitive adhesive layer, and a release liner disposed in this order, in which both adhesive faces of the pressure-sensitive adhesive layer were protected by the release liners. The double-sided pressure-sensitive adhesive sheet had a thickness (excluding the release liners) of 50 μm.

### Example 6

A double-sided pressure-sensitive adhesive sheet (pressure-sensitive adhesive transfer sheet) was prepared by a procedure similar to Example 5, except for forming a pressure-sensitive adhesive layer so as to have a thickness of 100 μm. The double-sided pressure-sensitive adhesive sheet had a thickness (excluding the release liners) of 100 μm.

### Example 7

A monomer mixture containing 28.5 parts by weight of 2-ethylhexyl acrylate (2EHA), 28.5 parts by weight of isostearyl acrylate (ISTA), 22 parts by weight of isobornyl acrylate (IBXA), and 21 part by weight of 4-hydroxybutyl acrylate (4HBA) was prepared. The monomer mixture was mixed with 0.05 part by weight of a photoinitiator (trade name IRGACURE 651, supplied by BASF SE) and 0.5 part by weight of another photoinitiator (trade name IRGACURE 184, supplied by BASF SE), followed by ultraviolet irradiation to a viscosity of about 20 Pa·s. This gave a prepolymer composition in which part of the monomer components was polymerized. The viscosity was measured using a BH viscometer with a No. 5 rotor at 10 rpm and at a measurement temperature of 30° C.

The prepolymer composition was combined with 0.3 part by weight of 1,6-hexanediol diacrylate (trade name NK Ester A-HD-N, supplied by Shin-Nakamura Chemical Co., Ltd.), 0.3 part by weight of a silane coupling agent (trade name KBM-403, supplied by Shin-Etsu Chemical Co., Ltd.), 0.05 part by weight of a photoinitiator (trade name IRGACURE 651, supplied by BASF SE), and 0.5 part by weight of another photoinitiator (trade name IRGACURE 819, supplied by BASF SE) and yielded an acrylic pressure-sensitive adhesive composition.

Except for using the acrylic pressure-sensitive adhesive composition, a double-sided pressure-sensitive adhesive sheet (pressure-sensitive adhesive transfer sheet) was prepared by a procedure similar to Example 1. The resulting article had a configuration including a release liner, a pressure-sensitive adhesive layer, and a release liner disposed in this order, in which both adhesive faces of the pressure-sensitive adhesive layer were protected by the release liners. The double-sided pressure-sensitive adhesive sheet had a thickness (excluding the release liners) of 50 μm.

### Example 8

A double-sided pressure-sensitive adhesive sheet (pressure-sensitive adhesive transfer sheet) was prepared by a procedure similar to Example 7, except for forming a pressure-sensitive adhesive layer so as to have a thickness of 100 μm. The double-sided pressure-sensitive adhesive sheet had a thickness (excluding the release liners) of 100 μm.

### Example 9

Into a separable flask, monomer components including 63 parts by weight of 2-ethylhexyl acrylate (2EHA), 9 parts by weight of methyl methacrylate (MMA), 15 parts by weight of N-vinyl-2-pyrrolidone (NVP), and 13 parts by weight of 2-hydroxyethyl acrylate (HEA); and, as a polymerization solvent, 175 parts by weight of ethyl acetate were placed. The mixture was stirred for one hour with introduction of nitrogen gas. After removing oxygen from the polymerization system in the above manner, the mixture was combined with 0.2 part by weight of 2,2′-azobisisobutyronitrile as a polymerization initiator. The temperature was raised to 63° C., and a reaction was performed for 10 hours. The reaction mixture was diluted with ethyl acetate and yielded an acrylic polymer solution having a solids concentration of 36 percent by weight. The acrylic polymer in the acrylic polymer solution had a weight-average molecular weight of 85×10⁴.

The acrylic polymer solution was mixed with 1.1 parts by weight of an isocyanate crosslinking agent (trade name TAKENATE D-110N, supplied by Mitsui Chemicals Inc.), 0.15 part by weight of a silane coupling agent (trade name KBM-403, supplied by Shin-Etsu Chemical Co., Ltd.), and 1.5 parts by weight of an ultraviolet absorber (trade name Tinuvin 384-2, supplied by BASF SE) and yielded an acrylic pressure-sensitive adhesive composition.

The acrylic pressure-sensitive adhesive composition was applied onto a poly(ethylene terephthalate) (PET) release liner (supplied by Nitto Denko Corporation, 125 μm in thickness) and yielded a pressure-sensitive adhesive composition layer. Next, the composition layer was dried by heating at 130° C. for 3 minutes to form a pressure-sensitive adhesive layer, onto which another poly(ethylene terephthalate) (PET) release liner (supplied by Nitto Denko Corporation, 125 μm in thickness) was applied. The resulting article was aged at 23° C. for 120 hours and yielded a double-sided pressure-sensitive adhesive sheet (pressure-sensitive adhesive transfer sheet). The resulting article had a configuration including a release liner, a pressure-sensitive adhesive layer, and a release liner disposed in this order, in which both adhesive faces of the pressure-sensitive adhesive layer were protected by the release liners. The double-sided pressure-sensitive adhesive sheet had a thickness (excluding the release liners) of 50 μm.

### Example 10

A double-sided pressure-sensitive adhesive sheet (pressure-sensitive adhesive transfer sheet) was prepared by a procedure similar to Example 9, except for forming a pressure-sensitive adhesive layer so as to have a thickness of 100 μm. The double-sided pressure-sensitive adhesive sheet had a thickness (excluding the release liners) of 100 μm.

### Example 11

In a separable flask, monomer components including 63 parts by weight of 2-ethylhexyl acrylate (2EHA), 9 parts by weight of methyl methacrylate (MMA), 15 parts by weight of N-vinyl-2-pyrrolidone (NVP), and 13 parts by weight of 2-hydroxyethyl acrylate (HEA); and, as a polymerization solvent, 175 parts by weight of ethyl acetate were placed. The mixture was stirred for one hour with introduction of nitrogen gas. After removing oxygen from the polymerization system in the above manner, the mixture was combined with 0.2 part by weight of 2,2′-azobisisobutyronitrile as a polymerization initiator. The temperature was raised to 63° C., and a reaction was performed for 10 hours. The reaction mixture was diluted with ethyl acetate and yielded an acrylic polymer solution having a solids concentration of 36 percent by weight. The acrylic polymer in the acrylic polymer solution had a weight-average molecular weight of 85×10⁴.

The acrylic polymer solution was mixed with 1.1 parts by weight of an isocyanate crosslinking agent (trade name TAKENATE D-110N, supplied by Mitsui Chemicals Inc.), 0.15 part by weight of a silane coupling agent (trade name KBM-403, supplied by Shin-Etsu Chemical Co., Ltd.), and 1 part by weight of an ultraviolet absorber (trade name KEMISORB 111, supplied by Chemipro Kasei Kaisha, Ltd.) and yielded an acrylic pressure-sensitive adhesive composition.

Except for using the acrylic pressure-sensitive adhesive composition, a double-sided pressure-sensitive adhesive sheet (pressure-sensitive adhesive transfer sheet) was prepared by a procedure similar to Example 9. The resulting article had a configuration including a release liner, a pressure-sensitive adhesive layer, and a release liner disposed in this order, in which both adhesive faces of the pressure-sensitive adhesive layer were protected by the release liners. The double-sided pressure-sensitive adhesive sheet had a thickness (excluding the release liners) of 50 μm.

### Comparative Example 1

A monomer mixture including 67 parts by weight of n-butyl acrylate (BA), 17 parts by weight of cyclohexyl acrylate (CHA), 8 parts by weight of 2-hydroxyethyl acrylate (HEA), and 27 parts by weight of 4-hydroxybutyl acrylate (4HBA) was prepared. The monomer mixture was combined with 0.05 part by weight of a photoinitiator (trade name IRGACURE 651, supplied by BASF SE) and 0.05 part by weight of another photoinitiator (trade name IRGACURE 184, supplied by BASF SE), followed by ultraviolet irradiation to a viscosity of about 20 Pa·s. This gave a prepolymer composition in which part of the monomer components was polymerized. The viscosity was measured using a BH viscometer with a No. 5 rotor at 10 rpm and at a measurement temperature of 30° C.

The prepolymer composition was mixed with 0.1 part by weight of dipentaerythritol hexaacrylate (DPHA) and 0.3 part by weight of a silane coupling agent (trade name KBM-403, supplied by Shin-Etsu Chemical Co., Ltd.) and yielded an acrylic pressure-sensitive adhesive composition.

Except of using the acrylic pressure-sensitive adhesive composition, a double-sided pressure-sensitive adhesive sheet (pressure-sensitive adhesive transfer sheet) was prepared by a procedure similar to Example 1. The resulting article had a configuration including a release liner, a pressure-sensitive adhesive layer, and a release liner disposed in this order, in which both adhesive faces of the pressure-sensitive adhesive layer were protected by the release liners. The double-sided pressure-sensitive adhesive sheet had a thickness (excluding the release liners) of 50 μm.

### Comparative Example 2

A double-sided pressure-sensitive adhesive sheet (pressure-sensitive adhesive transfer sheet) was prepared by a procedure similar to Comparative Example 1, except for forming a pressure-sensitive adhesive layer so as to have a thickness of 100 μm. The double-sided pressure-sensitive adhesive sheet had a thickness (excluding the release liners) of 100 μm.

### EVALUATIONS

The double-sided pressure-sensitive adhesive sheets prepared in the examples and comparative examples were examined on evaluations as follows. The results are shown in Table 1.

### (1) Extracted Acrylic Acid Ion Amount

Test Specimen Preparation

The double-sided pressure-sensitive adhesive sheets prepared in the examples and comparative examples were each cut to give sheet pieces 10 cm wide by 10 cm long. From the sheet pieces, the release liners were removed to expose two adhesive faces. A PET film (trade name LUMIRROR S10, supplied by Toray Industries Inc., 25 μm in thickness) was applied onto one of the two adhesive faces. This yielded test specimens in which only one adhesive face was exposed. The pressure-sensitive adhesive layers in the test specimens had a mass of 0.5 g at a thickness of the pressure-sensitive adhesive layer of 50 μm, and had a mass of 1 g at a thickness of the pressure-sensitive adhesive layer of 100 μm. Before use, the PET film had been subjected to extraction with heating (at 120° C. for one hour) and then washed with pure water. As used herein the term “extraction with heating” refers to extraction in which a sample placed in pure water is left stand for a predetermined time with heating at a predetermined temperature to extract an arbitrary component from the sample. For example, “extraction with heating (at 120° C. for one hour)” refers to extraction in which a sample in pure water is left stand for one hour with heating at 120° C. to extract an arbitrary component from the sample.

Acrylic Acid Ion Extraction with Heating

Next, each of the test specimens was placed in 50 ml of pure water, subjected to extraction with heating (at 100° C. for 45 minutes) in a dryer to give an extract.

Next, the amount (in microgram (μg)) of acrylic acid ions in the above-obtained extract was measured by ion chromatography, based on which the amount (extracted acrylic acid ion amount) per gram of the pressure-sensitive adhesive layer in each test specimen was calculated, where the amount is indicated in microgram per gram (μg/g). The results are shown in Table 1.

Ion Chromatographic Measurement Conditions

Analyzer: ICS-3000 supplied by Thermo Fisher Scientific Inc.;

Separation column: Ion Pac AS18 (4 mm by 250 mm);

Guard column: Ion Pac AG18 (4 mm by 50 mm);

Suppressor system: AERS-500 (external mode);

Detector: conductivity detector;

Eluent: KOH aqueous solution, using Eluent Generator EG III);

Eluent flow rate: 1.0 ml/min.; and

Sample injection volume: 250 μl.

### (2) UV-Resistant Non-Corrosivity

Silver Nanowire Synthesis and Silver Nanowire Dispersion Preparation

In a reactor equipped with a stirrer, 5 ml of anhydrous ethylene glycol and 0.5 ml of a PtCl₂ solution (having a concentration of 1.5×10⁻⁴ mol/l) in anhydrous ethylene glycol were placed at 160° C. After a lapse of 4 minutes, the resulting solution was combined with 2.5 ml of an AgNO₃ solution (having a concentration of 0.12 mol/l) in anhydrous ethylene glycol and 5 ml of a polyvinylpyrrolidone (Mw: 55000) solution (having a concentration of 0.36 mol/l) in anhydrous ethylene glycol both added dropwise simultaneously over 6 minutes. After the dropwise addition, the mixture was heated to 160° C., followed by reaction for one hour or longer until AgNO₃ was entirely reduced, and yielded crude silver nanowires. Next, the reaction mixture containing the prepared crude silver nanowires was combined with acetone to increase in volume of the reaction mixture by 5 times, the resulting reaction mixture was subjected to centrifugal separation (at 2000 rpm for 20 minutes), and yielded silver nanowires.

The prepared silver nanowires measured 30 nm to 40 nm in minor axis of wire cross section, 30 nm to 50 nm in major axis of wire cross section, and 30 μm to 50 μm in wire length.

In 100 parts by weight of pure water, 0.2 part by weight of the silver nanowires and 0.1 part by weight of pentaethylene glycol dodecyl ether were dispersed, and yielded a silver nanowire dispersion.

Protective Layer-Forming Composition Preparation

A solvent used herein was a 1:1 (by weight) mixture of isopropyl alcohol (supplied by Wako Pure Chemical Industries, Ltd.) and diacetone alcohol (supplied by Wako Pure Chemical Industries, Ltd.). Into 100 parts by weight of the solvent, 3.0 parts by weight of dipentaerythritol hexaacrylate (DPHA) (trade name A-DPH, supplied by Shin-Nakamura Chemical Co., Ltd.) and 0.09 part by weight of a photoinitiator (trade name IRGACURE 907, supplied by BASF SE) were placed, and yielded a protective layer-forming composition.

Transparent Conductive Film (1) Preparation

A transparent substrate used herein was a norbornene-cyclohexane cycloolefinic film (trade name ZEONOR, supplied by ZEON CORPORATION, having an in-plane retardation Re of 1.7 nm and a thickness direction retardation Rth of 1.8 nm) was used.

The silver nanowire dispersion was applied onto the entire surface of the transparent substrate using a bar coater (trade name Bar Coater No. 20, supplied by Dai-ichi Rika Co., Ltd.) and dried in a fan dryer at 120° C. for 2 minutes to form a silver nanowire layer. The protective layer-forming composition was then applied to the entire surface of the silver nanowire layer so as to have a wet thickness of 4 μm using a slot die and dried in a fan dryer at 120° C. for 2 minutes. Next, an ultraviolet ray was applied to an integrated illuminance of 400 mJ/cm² using an ultraviolet irradiator (supplied by Heraeus Noblelight America LLC. (former name Fusion UV Systems Inc.)), in which the oxygen concentration was adjusted to be 100 ppm. Thus, the protective layer-forming composition was cured to form a protective layer. This gave a transparent conductive film (1) having a configuration including the transparent substrate and the transparent conductive layer disposed on the transparent substrate. The transparent conductive layer included the silver nanowire layer and the protective layer.

The transparent conductive film (1) had a surface resistance of 50 Ω/square, a total luminous transmittance of 91.4%, and a haze of 2.0%.

Resistance Measurement

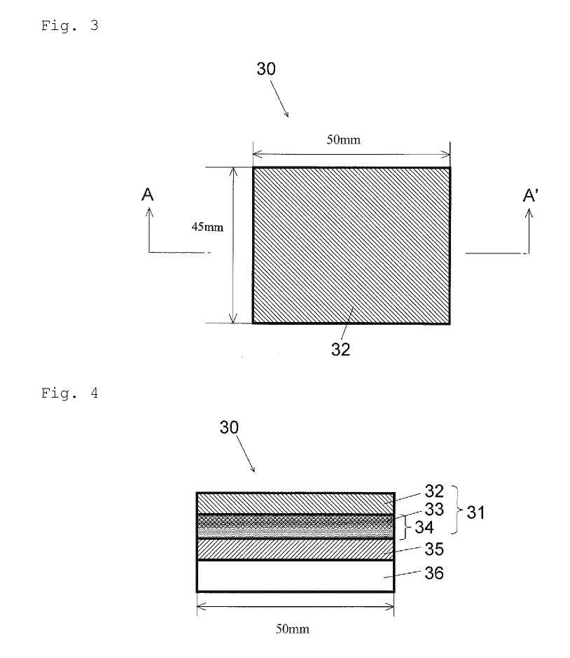

The release liners were removed from each of the double-sided pressure-sensitive adhesive sheets prepared in the examples and comparative examples to expose two adhesive faces. One of the two adhesive faces was affixed to the transparent conductive layer surface (side at which the silver nanowire layer had been formed) of the transparent conductive film (1), and the other adhesive face was affixed to a glass plate (trade name MICRO SLIDE GLASS 5200200, supplied by Matsunami Glass Ind., Ltd., measuring 50 mm in length, 45 mm in width, and 1.2 to 1.5 mm in thickness), and yielded a laminate. Next, from the laminate, portions of the transparent conductive film (1) and the double-sided pressure-sensitive adhesive sheet protruded from the glass plate were cut off, and this gave a series of test specimens as illustrated in FIGS. 3 and 4. The test specimens were 50 mm in length by 45 mm in width.

The test specimens each had a resistance of 50 Ω/square, and this resistance was defined as a “resistance immediately after affixation”. Next, the test specimens were left stand for 100 hours with ultraviolet irradiation at an illuminance of 65 W/m² from the glass plate side of the test specimen. The ultraviolet irradiation was performed using the Super Xenon Weather Meter SX75 (supplied by Suga Test Instruments Co., Ltd.). The irradiation was performed in an atmosphere at a temperature of 45° C. and relative humidity of 50%. The test specimen after being left stand for 100 hours was examined to measure a resistance, and the measured resistance was defined as a “resistance after 100-hour UV irradiation”. The ratio of the “resistance after 100-hour UV irradiation” to the “resistance immediately after affixation” was determined, and this was defined as a “rate of resistance increase” (in time) and shown in Table 1. The lower the rate of resistance increase is, the better the UV-resistant non-corrosivity is. The “resistance immediately after affixation” and the “resistance after 100-hour UV irradiation” were measured using the EC-80 supplied by NAPS ON CORPORATION.

TABLE 1

| | | | | | | | | | | | | Com. | Com. |
|---|---|---|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 1 | Ex. 2 |
| Pressure-sensitive | 50 | 100 | 50 | 100 | 50 | 100 | 50 | 100 | 50 | 100 | 50 | 50 | 100 |
| adhesive sheet thickness | | | | | | | | | | | | | |
| (μm) | | | | | | | | | | | | | |
| Extracted acrylic acid ion | 4.3 | 4.3 | <0.49 | 0.1 | <0.47 | 0.0 | 3.1 | 3.1 | 0.28 | 0.28 | <0.45 | 6.4 | 6.4 |
| amount (μg/g) | | | | | | | | | | | | | |
| Rate of resistance | 2.4 | 4.3 | 1.2 | 1.2 | 1.14 | 1.1 | 1.9 | 2.5 | 1.06 | 1.11 | 1.02 | 33.2 | 5.0 |
| increase (time) | | | | | | | | | | | | | |

As a summary of these, configurations, and variations thereof, of the present invention will be listed as supplementary notes below.

Note 1

An optical pressure-sensitive adhesive sheet for silver nanowire layer use. The optical pressure-sensitive adhesive sheet includes a pressure-sensitive adhesive layer. The amount of acrylic acid ions extracted from the pressure-sensitive adhesive layer with pure water at 100° C. for 45 minutes is equal to or less than 5 μg per gram of the pressure-sensitive adhesive layer, where the amount is measured by ion chromatography.

Note 2

The optical pressure-sensitive adhesive sheet according to Note 1, in which the pressure-sensitive adhesive layer is an acrylic pressure-sensitive adhesive layer containing an acrylic polymer.

Note 3

The optical pressure-sensitive adhesive sheet according to one of Notes 1 and 2, in which the pressure-sensitive adhesive layer contains an ultraviolet absorber.

Note 4

The optical pressure-sensitive adhesive sheet according to Note 3, in which the ultraviolet absorber has an absorbance A of equal to or less than 0.5, where the absorbance A is specified as an absorbance of a 0.08% solution of the ultraviolet absorber in toluene and is determined upon irradiation of the solution with light at a wavelength of 400 nm.

Note 5

The optical pressure-sensitive adhesive sheet according to one of Notes 3 and 4, in which the ultraviolet absorber is at least one ultraviolet absorber selected from the group consisting of benzotriazole ultraviolet absorbers, benzophenone ultraviolet absorbers, and hydroxyphenyltriazine ultraviolet absorbers.

Note 6

The optical pressure-sensitive adhesive sheet according to any one of Notes 3 to 5, in which the pressure-sensitive adhesive layer contains the ultraviolet absorber in a proportion of 0.01 to 10 parts by weight per 100 parts by weight of a base polymer in the pressure-sensitive adhesive layer.

Note 7

The optical pressure-sensitive adhesive sheet according to any one of Notes 2 to 6, in which the acrylic polymer is derived from at least one constitutive monomer component approximately devoid of acidic-group-containing monomers.

Note 8

The optical pressure-sensitive adhesive sheet according to any one of Notes 2 to 7, in which the acrylic polymer is derived from constitutive monomer components in which a proportion of a monomer that gives a homopolymer having a glass transition temperature of equal to or higher than 20° C. is 1 to 50 percent by weight based on the total weight (100 percent by weight) of all the monomer components to constitute the acrylic polymer.

Note 9

The optical pressure-sensitive adhesive sheet according to any one of Notes 2 to 8, in which the acrylic polymer includes a constitutional unit derived from a nitrogen-containing monomer and a constitutional unit derived from a hydroxy-containing monomer.

Note 10

The optical pressure-sensitive adhesive sheet according to any one of Notes 2 to 9, in which the acrylic polymer is derived from a monomer mixture. This monomer mixture includes 50 to 90 percent by weight of a (meth)acrylic alkyl ester containing a C₄-C₁₈ straight- or branched-chain alkyl group, 10 to 50 percent by weight of at least one monomer selected from the group consisting of nitrogen-containing monomers and hydroxy-containing monomers, and 0 to 40 percent by weight of a monomer having a C₆-C₁₀ alicyclic structure.

Note 11

The optical pressure-sensitive adhesive sheet according to any one of Notes 2 to 10, in which the acrylic polymer is derived from a monomer mixture. This monomer mixture includes 50 to 90 percent by weight of a (meth)acrylic alkyl ester containing a C₄-C₁₈ straight- or branched-chain alkyl group, 3 to 30 percent by weight of a nitrogen-containing monomer, 0.8 to 25 percent by weight of a hydroxy-containing monomer, and 0 to 40 percent by weight of a monomer having a C₆-C₁₀ alicyclic structure. In the monomer mixture, the total of proportions of the nitrogen-containing monomer and the hydroxy-containing monomer is 10 to 50 percent.

Note 12

The optical pressure-sensitive adhesive sheet according to any one of Notes 2 to 11, in which the acrylic pressure-sensitive adhesive layer further contains a silane coupling agent in a proportion of 0.01 to 1 part by weight per 100 parts by weight of the acrylic polymer.

Note 13

The optical pressure-sensitive adhesive sheet according to any one of Notes 2 to 12, in which the acrylic pressure-sensitive adhesive layer is a solvent-based acrylic pressure-sensitive adhesive layer. The acrylic pressure-sensitive adhesive layer contains the acrylic polymer in a content of equal to or more than 50 percent by weight based on the total weight (100 percent by weight) of the pressure-sensitive adhesive layer; and an ultraviolet absorber in a proportion of 0.05 to 9 parts by weight per 100 parts by weight of the acrylic polymer.

Note 14

The optical pressure-sensitive adhesive sheet according to any one of Notes 1 to 13, in which the pressure-sensitive adhesive layer has a haze of equal to or less than 5%.

Note 15

The optical pressure-sensitive adhesive sheet according to any one of Notes 1 to 14, in which the pressure-sensitive adhesive layer has a total luminous transmittance of equal to or more than 85%.

Note 16

The optical pressure-sensitive adhesive sheet according to any one of Notes 1 to 15, in which, when the optical pressure-sensitive adhesive sheet is affixed to an optical element including a silver nanowire layer to form an article, the article has a resistance after ultraviolet irradiation for 100 hours of equal to or less than 3 times the resistance of the article immediately after the affixation of the pressure-sensitive adhesive sheet to the optical element.

Note 17

The optical pressure-sensitive adhesive sheet according to any one of Notes 1 to 16, for use in a film sensor.

### REFERENCE SIGNS LIST

1 optical product
11 cover
12 optical pressure-sensitive adhesive sheet according to the embodiment of the present invention
13 carrier
14 silver nanowire layer
15 protective layer
30 test specimen
31 transparent conductive film (1)
32 transparent substrate
33 silver nanowire layer
34 protective layer
35 double-sided pressure-sensitive adhesive sheet
36 glass plate

1. An optical pressure-sensitive adhesive sheet for silver nanowire layer use, the optical pressure-sensitive adhesive sheet comprising
a pressure-sensitive adhesive layer,
wherein an amount of acrylic acid ions extracted from the pressure-sensitive adhesive layer with pure water at 100° C. for 45 minutes is equal to or less than 5 μg per gram of the pressure-sensitive adhesive layer, where the amount is measured by ion chromatography.

2. The optical pressure-sensitive adhesive sheet according to claim 1,
wherein the pressure-sensitive adhesive layer is an acrylic pressure-sensitive adhesive layer comprising an acrylic polymer.

3. The optical pressure-sensitive adhesive sheet according to claim 1,
wherein the pressure-sensitive adhesive layer comprises an ultraviolet absorber.

4. The optical pressure-sensitive adhesive sheet according to claim 3,
wherein the ultraviolet absorber has an absorbance A of equal to or less than 0.5, where the absorbance A is specified as an absorbance of a 0.08% solution of the ultraviolet absorber in toluene and is determined upon irradiation of the solution with light at a wavelength of 400 nm.

5. The optical pressure-sensitive adhesive sheet according to claim 3,
wherein the ultraviolet absorber comprises at least one ultraviolet absorber selected from the group consisting of:
benzotriazole ultraviolet absorbers;
benzophenone ultraviolet absorbers; and
hydroxyphenyltriazine ultraviolet absorbers.

6. The optical pressure-sensitive adhesive sheet according to claim 3,
wherein the pressure-sensitive adhesive layer comprises the ultraviolet absorber in a proportion of 0.01 to 10 parts by weight per 100 parts by weight of a base polymer in the pressure-sensitive adhesive layer.

7. The optical pressure-sensitive adhesive sheet according to claim 2,
wherein the acrylic polymer is derived from at least one constitutive monomer component approximately devoid of acidic-group-containing monomers.

8. The optical pressure-sensitive adhesive sheet according to claim 2,
wherein the acrylic polymer is derived from constitutive monomer components in which a proportion of a monomer that gives a homopolymer having a glass transition temperature of equal to or higher than 20° C. is 1 to 50 percent by weight based on the total weight (100 percent by weight) of all the monomer components to constitute the acrylic polymer.

9. The optical pressure-sensitive adhesive sheet according to claim 2,
wherein the acrylic polymer includes:
a constitutional unit derived from a nitrogen-containing monomer; and
a constitutional unit derived from a hydroxy-containing monomer.

10. The optical pressure-sensitive adhesive sheet according to claim 2,
wherein the acrylic polymer is derived from a monomer mixture including:
50 to 90 percent by weight of a (meth)acrylic alkyl ester containing a C₄-C₁₈ straight- or branched-chain alkyl group;
10 to 50 percent by weight of at least one monomer selected from the group consisting of nitrogen-containing monomers and hydroxy-containing monomers; and
0 to 40 percent by weight of a monomer having a C₆-C₁₀ alicyclic structure.

11. The optical pressure-sensitive adhesive sheet according to claim 2,
wherein the acrylic polymer is derived from a monomer mixture including:
50 to 90 percent by weight of a (meth)acrylic alkyl ester containing a C₄-C₁₈ straight- or branched-chain alkyl group;
3 to 30 percent by weight of a nitrogen-containing monomer;
0.8 to 25 percent by weight of a hydroxy-containing monomer; and
0 to 40 percent by weight of a monomer having a C₆-C₁₀ alicyclic structure,
wherein the monomer mixture contains the nitrogen-containing monomer and the hydroxy-containing monomer in a total content of 10 to 50 percent by weight.

12. The optical pressure-sensitive adhesive sheet according to claim 2,
wherein the acrylic pressure-sensitive adhesive layer further comprises a silane coupling agent in a proportion of 0.01 to 1 part by weight per 100 parts by weight of the acrylic polymer.

13. The optical pressure-sensitive adhesive sheet according to claim 2,
wherein the acrylic pressure-sensitive adhesive layer is a solvent-based acrylic pressure-sensitive adhesive layer, and
the acrylic pressure-sensitive adhesive layer includes:
the acrylic polymer in a content of equal to or more than 50 percent by weight based on the total weight (100 percent by weight) of the pressure-sensitive adhesive layer; and
an ultraviolet absorber in a proportion of 0.05 to 9 parts by weight per 100 parts by weight of the acrylic polymer.

14. The optical pressure-sensitive adhesive sheet according to claim 1,
wherein the pressure-sensitive adhesive layer has a haze of equal to or less than 5%.

15. The optical pressure-sensitive adhesive sheet according to claim 1,
wherein the pressure-sensitive adhesive layer has a total luminous transmittance of equal to or more than 85%.

16. The optical pressure-sensitive adhesive sheet according to claim 1,
wherein, when the optical pressure-sensitive adhesive sheet is affixed to an optical element including a silver nanowire layer to form an article, the article has a resistance after ultraviolet irradiation for 100 hours of equal to or less than 3 times a resistance of the article immediately after the affixation of the pressure-sensitive adhesive sheet to the optical element.

17. The optical pressure-sensitive adhesive sheet according to claim 1, for use in a film sensor.
